(19) United States
(12) Patent Application Publication
(10) Pub. No.: US 2025/0329174 A1
(43) Pub. Date: Oct. 23, 2025

(54) VEHICULAR DRIVER MONITORING SYSTEM WITH DRIVER MONITORING CAMERA AND NEAR IR LIGHT EMITTER AT INTERIOR REARVIEW MIRROR ASSEMBLY

(71) Applicant: Magna Mirrors of America, Inc., Holland, MI (US)

(72) Inventors: Darryl P. De Wind, West Olive, MI (US); Anthony J. LaCross, Hastings, MI (US); Austen C. Peterson, Hudsonville, MI (US); Justin E. Sobecki, Rockford, MI (US)

(21) Appl. No.: 18/864,663

(22) PCT Filed: May 11, 2023
(86) PCT No.: PCT/US2023/021799

§ 371 Date: Nov. 11, 2024

Related U.S. Application Data
(60) Provisional application No. 63/364,637, filed on May 13, 2022.
(60) Provisional application No. 63/491,097, filed on Mar. 20, 2023.

(51) Int. Cl. G06V 20/59; B60R 1/08; B60R 1/26; H04N 7/18; H04N 23/57

(52) U.S. Cl. CPC G06V 20/597; B60R 1/08; B60R 1/26; H04N 7/183; H04N 23/57; B60R 2300/8026; B60R 2300/8066

(57) ABSTRACT

A vehicular driver monitoring system includes a vehicular interior rearview mirror assembly having a mirror head that accommodates a mirror reflective element. A video display is disposed behind the mirror reflective element and operable to display video images captured by a rearward viewing camera of the vehicle. A driver monitoring camera and a near infrared light emitter are accommodated by and move in tandem with the mirror head. The near infrared light emitter is accommodated within the mirror head so that, with the mirror head adjusted relative to the mounting base to set the rearward view of the driver of the vehicle, a beam of near infrared light emitted by the near infrared light emitter is directed toward a driver's region of the vehicle. The driver monitoring camera is disposed adjacent to the video display screen so as to not view through the video display screen.

### CROSS REFERENCE TO RELATED APPLICATIONS

The present application claims the filing benefits of U.S. provisional application Ser. No. 63/491,097, filed Mar. 20, 2023, and U.S. provisional application Ser. No. 63/364,637, filed May 13, 2022, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

An interior rearview mirror assembly has a driver monitoring camera and a near infrared light emitter disposed at the mirror head so as to move in tandem with the mirror head when the mirror head is adjusted relative to an interior portion of the vehicle to adjust the driver's rearward view. The mirror head includes a video display screen disposed behind the mirror reflective element. The video display screen, when operated, displays video images that are viewable through the mirror reflective element by a driver of the vehicle. The camera may view the interior cabin of the vehicle through the mirror reflective element and the near infrared light emitter may emit near infrared light through the mirror reflective element to illuminate the driver region and/or passenger region of the interior cabin of the vehicle. The camera is located at the mirror head outboard of the video display screen, and the camera is rendered covert by a portion of the mirror reflective element or a separate cover panel at the mirror reflective element.

These and other objects, advantages, purposes and features of the present invention will become apparent upon review of the following specification in conjunction with the drawings.

### BRIEF DESCRIPTION OF THE DRAWINGS

FIG. 1 is a view of an interior rearview mirror assembly having a driver monitoring camera and near infrared light emitters;

FIG. 2 shows views of the camera and emitters of the interior rearview mirror assembly of FIG. 1, and cones of light emitted by the emitters;

FIG. 3A is a view of the mirror reflective element of the interior rearview mirror assembly of FIG. 1, showing an EC active region, with the camera and light emitters outboard of the EC active region;

FIG. 3B is a view of the mirror reflective element of the interior rearview mirror assembly of FIG. 1, with the front glass substrate removed;

FIG. 4 shows views of the reflective element of the interior rearview mirror assembly of FIG. 1;

FIG. 5 is a view of another interior rearview mirror assembly having a driver monitoring camera and near infrared light emitters;

FIG. 6 shows views of the camera and emitters of the interior rearview mirror assembly of FIG. 5, and cones of light emitted by the emitters;

FIG. 7A is a view of the mirror reflective element of the interior rearview mirror assembly of FIG. 5, showing an EC active region, with the camera and light emitters outboard of the EC active region;

FIG. 7B is a view of the mirror reflective element of the interior rearview mirror assembly of FIG. 5, with the front glass substrate removed;

FIG. 8 shows views of the reflective element of the interior rearview mirror assembly of FIG. 5;

FIG. 9 is a view of another interior rearview mirror assembly having a driver monitoring camera and near infrared light emitters;

FIG. 10 shows views of the camera and emitters of the interior rearview mirror assembly of FIG. 9, and cone of light emitted by the emitters;

FIG. 11A is a view of the mirror reflective element of the interior rearview mirror assembly of FIG. 9, showing an EC active region, with the camera and light emitters outboard of the EC active region;

FIG. 11B is a view of the mirror reflective element of the interior rearview mirror assembly of FIG. 9, with the front glass substrate removed;

FIG. 12 shows views of the reflective element of the interior rearview mirror assembly of FIG. 9;

FIG. 13 shows a comparison of the mirror assemblies of FIGS. 1, 5, and 9;

FIG. 14 is a view of another interior rearview mirror assembly having a driver monitoring camera and near infrared light emitters;

FIG. 15 is a view of a mirror reflective element, showing possible dimensions of the rear glass substrate and video display screen to accommodate the camera;

FIGS. 16-19 show different mirror reflective elements of mirror assemblies that accommodate the camera and light emitters;

FIG. 20 shows different views of the camera, showing variations in views as the cover panel angle relative to the mirror reflective element and the camera is varied;

FIGS. 21 and 22 show the different angles of the cover panel relative to the mirror reflective element and the camera;

FIGS. 23 and 24 show another mirror reflective element that accommodates the camera at a chin region;

FIG. 25 shows the view of the camera through the front glass substrate of the mirror reflective element;

FIGS. 26-28 show different chin sizes and shapes for the mirror reflective element;

FIGS. 29-31 show the camera and cover panel angled relative to the mirror reflective element;

FIG. 32 is a view of another interior rearview mirror assembly having a driver monitoring camera and near infrared light emitters;

FIG. 33 is a view of another interior rearview mirror assembly having a driver monitoring camera and near infrared light emitters;

FIG. 34 is a view of another interior rearview mirror assembly having a driver monitoring camera and near infrared light emitters;

FIG. 35 is a view of another interior rearview mirror assembly having a driver monitoring camera and near infrared light emitters;

FIG. 36 is a view of another interior rearview mirror assembly having a driver monitoring camera and near infrared light emitters;

FIGS. 37-39 are views of another interior rearview mirror assembly having a driver monitoring camera and near infrared light emitters;

FIGS. 40 and 41 are views of another interior rearview mirror assembly having a driver monitoring camera and near infrared light emitters;

FIGS. 42-44 are views of another interior rearview mirror assembly having a driver monitoring camera and near infrared light emitters;

FIGS. 45 and 46 are views of another interior rearview mirror assembly having a driver monitoring camera and near infrared light emitters;

FIGS. 47 and 48 are views of another interior rearview mirror assembly having a driver monitoring camera and near infrared light emitters;

FIGS. 49 and 50 are views of another interior rearview mirror assembly having a driver monitoring camera and near infrared light emitters;

FIGS. 51 and 52 show a comparison of the mirror reflective elements of FIGS. 37-50;

FIGS. 53-57 are views of another interior rearview mirror assembly having a driver monitoring camera and near infrared light emitters;

FIGS. 58-63 are views of other interior rearview mirror assemblies having a driver monitoring camera and near infrared light emitters;

FIG. 64 shows different cameras suitable for use as a driver monitoring or occupant monitoring camera;

FIGS. 65-71 are views of another interior rearview mirror assembly having a mini DMS camera and near infrared light emitters; and

FIG. 72 is a driver eye position chart.

### DESCRIPTION OF THE PREFERRED EMBODIMENTS

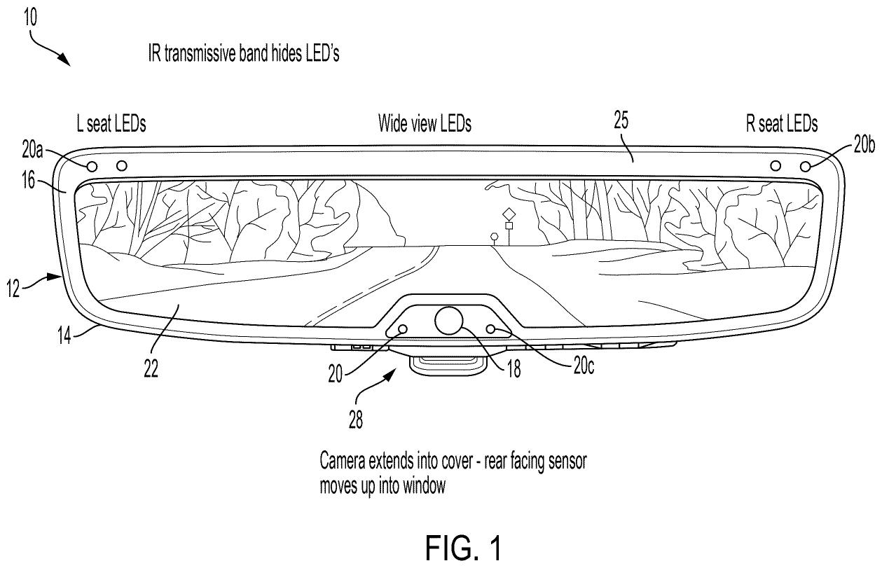

Referring now to the drawings and the illustrative embodiments depicted therein, an interior rearview mirror assembly 10 for a vehicle includes a mirror head 12 having a casing 14 and a reflective element 16 positioned at a front portion of the casing (FIG. 1). In the illustrated embodiment, the mirror assembly is configured to be adjustably mounted to an interior portion of a vehicle (such as to an interior or in-cabin surface of a vehicle windshield or a headliner of a vehicle or the like) via a mounting structure or mounting configuration or assembly. The mirror reflective element 16 may include a variable reflectance mirror reflective element that varies its reflectance responsive to electrical current applied to conductive coatings or layers of the reflective element.

The mirror assembly includes or is associated with a driver monitoring system (DMS), with the mirror assembly including a driver/occupant monitoring camera 18 disposed at a back plate (and viewing through an aperture of the back plate) behind the reflective element 16 and viewing through the reflective element 16 toward at least a head region of the driver of the vehicle. The DMS includes a near infrared light emitter 20 disposed at the back plate and emitting light through another aperture of the back plate and through the reflective element 16. Optionally, the mirror assembly includes a plurality of infrared light emitters and/or a plurality of cameras viewing through the mirror reflective element 16 and capturing image data representative of different respective fields of view of the interior portion of the vehicle, such as for monitoring a front passenger seat position and/or for monitoring one or more rear seat positions of the vehicle. That is, the mirror assembly may include a plurality of cameras, where each camera of the plurality of cameras may be disposed at a respective aperture formed through the back plate and view through the mirror reflective element and the mirror assembly may include a plurality of light emitters, where each light emitter of the plurality of light emitters may be disposed at a respective aperture formed through the back plate and emit light through the mirror reflective element. The one or more cameras and the one or more near infrared light emitters move together and in tandem with the mirror head when the mirror head is adjusted relative to the mounting base to set the rearward view of the driver provided by the mirror reflective element.

The driver monitoring system, including the cameras and processor, may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2022-0111857; US-2021-0323473; US-2021-0291739; US-2020-0202151; US-2020-0143560; US-2020-0320320; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2022/241423; WO 2022/187805 and/or WO 2023/034956, which are all hereby incorporated herein by reference in their entireties.

The interior rearview mirror assembly includes a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. In other words, the mirror head includes a video display screen 22 and the video display screen 22 of the video mirror. When the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. When the video display screen 22 is operated to display video images captured by the rearward viewing camera, light emitted by the video display device passes through the mirror reflective element for viewing by the driver of the vehicle.

The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The likes of Full Display Mirrors available from Gentex Corp. of Zeeland, MI and ClearView™ Interior Rearview Mirrors available from Magna Mirrors of America, Inc. of Grand Rapids, MI, are proliferating in vehicles. In such interior rearview video mirrors, video feed captured by a rearward viewing camera (optionally or additionally by an exterior driver-side rearward viewing camera and an exterior passenger-side rearward viewing camera) is displayed at the interior video mirror (such as by utilizing aspects of the systems described in U.S. Pat. Nos. 11,242,008; 11,214,199; 10,442,360; 10,421,404; 10,166,924; 10,046,706 and/or 10,029,614, which are all hereby incorporated herein by reference in their entireties). Such full display video mirrors typically utilize a liquid crystal (LC) thin film transistor (TFT) video screen or an organic light emitting diode (OLED) video screen that is covertly disposed behind the mirror reflector of the interior rearview mirror assembly. The video screen has a screen area that substantially matches and fills the area of the mirror reflective element that is viewed by the driver of the vehicle. For example, the video display screen length dimension (lateral dimension across the vehicle when the mirror assembly is installed in the vehicle) may span at least 75 percent of the reflective element length and the video display screen width dimension (vertical dimension when the mirror assembly is installed in the vehicle) may span at least 75 percent of the reflective element width dimension. Optionally, the video display screen length dimension may span at least 95 percent of the reflective element length and the video display screen width dimension may span at least 95 percent of the reflective element width dimension.

In other words, the mirror reflective element includes a mirror reflector, such as a transflective mirror reflector, that defines a reflective region of the mirror reflective element. The video display screen is disposed rearward of the mirror reflective element. The transflective mirror reflector allows at least some light to pass through the mirror reflective element (e.g., at least a portion of visible light emitted from within the mirror head so that light emitted by the video display screen may be viewed by the driver of the vehicle) while blocking at least some light from passing through the mirror reflective element (e.g., at least a portion of visible light incident on the outer surface of the mirror reflective element to provide the reflective quality of the mirror reflective element). For example, the transflective mirror reflector may transmit at least a portion of near infrared (near IR) light incident thereon, transmit at least a portion of visible light incident thereon and reflect at least a portion of visible light incident thereon.

As discussed further below, the video display screen 22 includes a full display video screen 22 and the interior rearview mirror assembly 10 includes the one or more DMS/OMS cameras 18. The DMS camera 18 is disposed within the mirror head 12 so that the DMS camera 18 does not view through the video display screen 22 itself, so that the camera 18 is not occluded by the video screen 22. In other words, the video display screen 22 does not extend in front of or over the DMS camera 18. Further, the DMS camera 18, and also the driver illuminating supplemental near infrared light emitters 20, are accommodated discretely or covertly in the interior rearview mirror assembly so that their presence is not readily noticeable to the likes of the driver sitting at the driver seat and operating the vehicle. For example, and such as shown in FIGS. 1-14, the rear glass substrate of the mirror reflective element may be notched to provide a space for the camera 18 (and the LC display is similarly notched) to create an overhang created by the front glass substrate (that is not notched). That is, the rear glass substrate and the video screen include respective notched areas or regions that align or overlap or correspond to one another, and the camera is disposed at the back plate of the mirror assembly at a position corresponding to the notched region and viewing through the front glass substrate of the mirror reflective element.

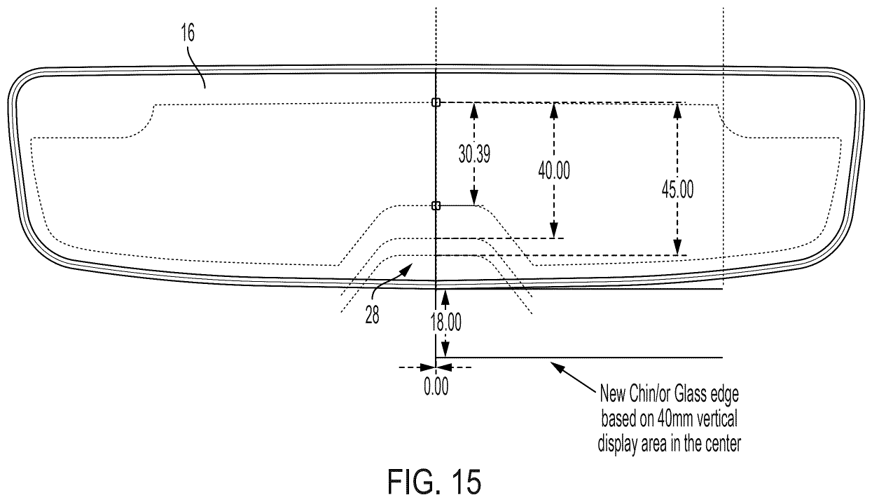

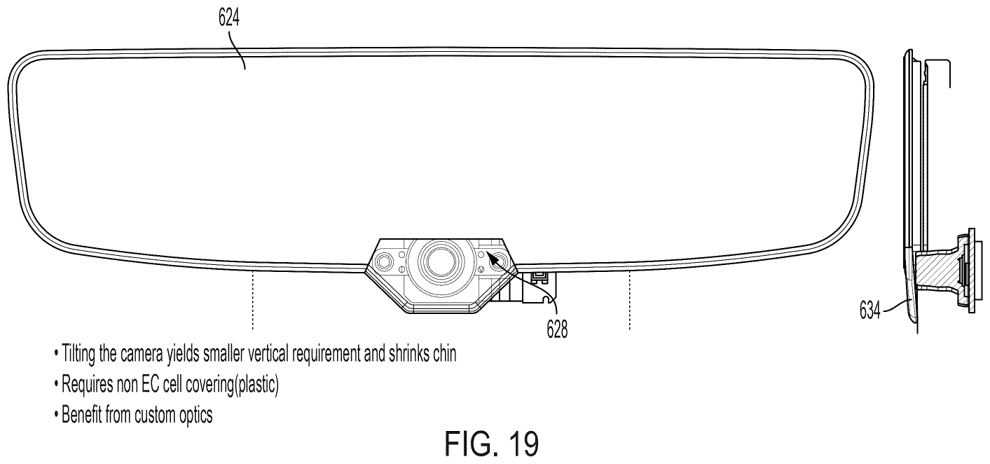

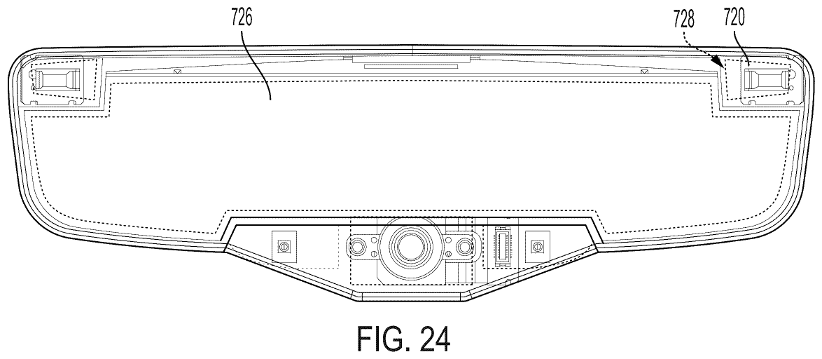

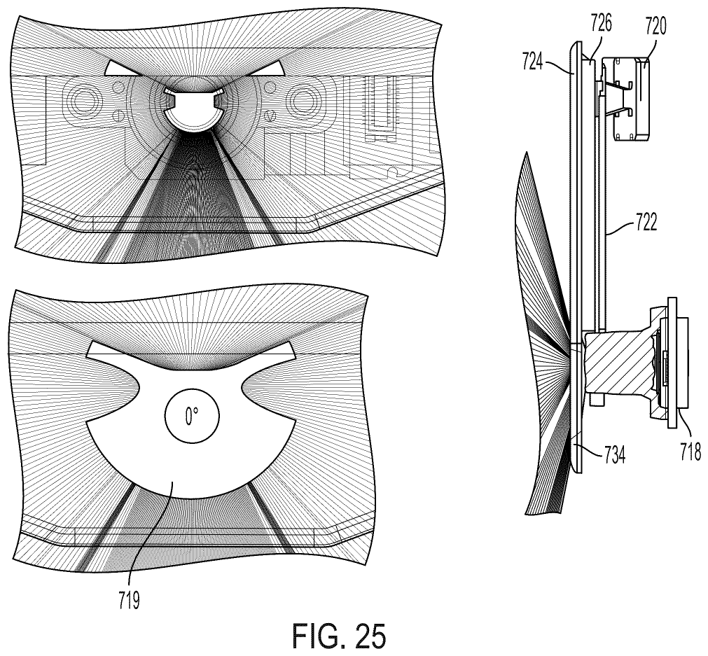

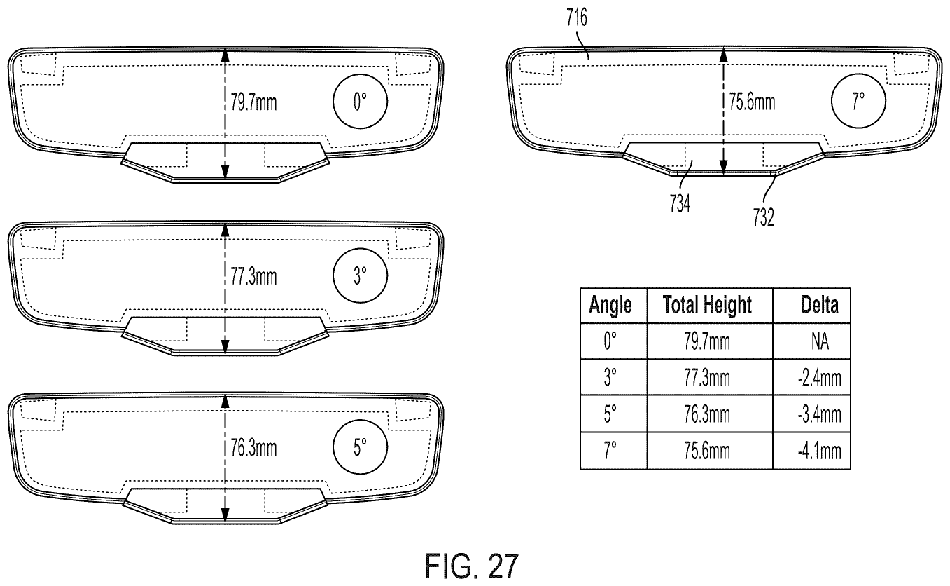

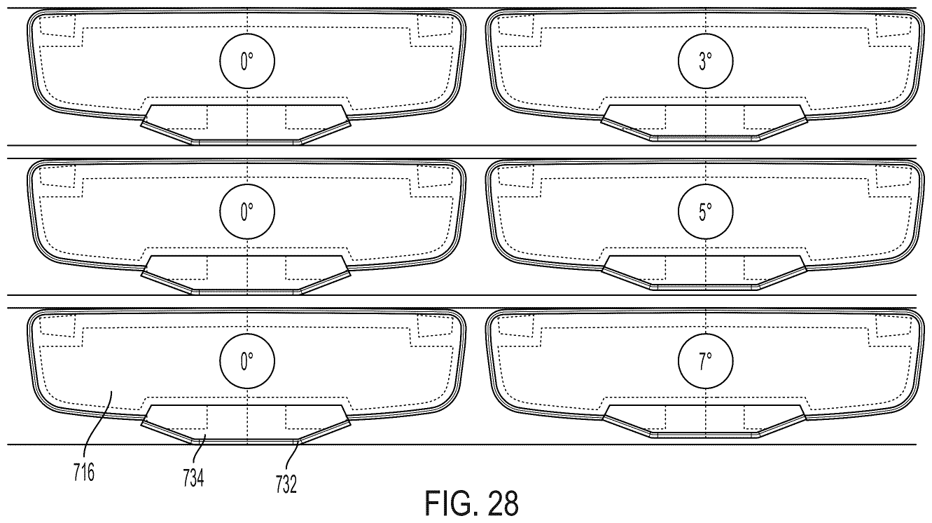

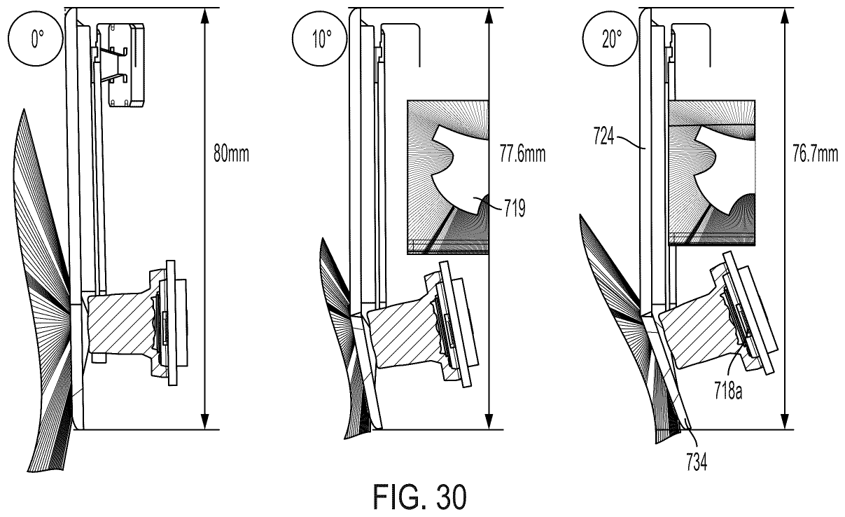

An infrared (IR) or near infrared (near IR) transmissive band or coating 25 may be disposed at the front glass substrate 24 (such as at an exterior surface of the front glass substrate) and the IR transmissive band 25 may permit IR and/or near IR light to pass through the band 25 while blocking or substantially blocking visible light from passing through the band 25. Thus, the IR transmissive band 25 may be disposed at the front glass substrate 24 over and along the light emitters 20 and/or camera 18 (such as at a perimeter or peripheral region of the mirror reflective element) to render the light emitters 20 and/or camera 18 covert to the driver of the vehicle while permitting IR and/or near IR light to pass through the band 25 for IR illumination of the vehicle cabin and capture of image data representative of reflected IR light for DMS and/or OMS functionality. Optionally, and such as shown in FIGS. 15-30, the front glass substrate (or a separate cover element) may extend downward to conceal or render covert the camera disposed at a lower perimeter region of the notched or un-notched rear glass substrate.

Optionally, the video display screen may include an OLED that can be at least locally rendered transparent. With such a display screen, the camera 18 (and optionally the near infrared light emitters 20) may be disposed at and behind the OLED display screen, whereby, when the system is performing a driver monitoring function (or occupant monitoring function), the OLED display screen may be operated to locally render the display screen in front of the camera 18 (and optionally the near infrared light emitters 20) transparent. That is, a region or portion of the OLED display screen that is in front of or corresponds to the position of the camera 18 and/or light emitter 20 may be rendered at least partially transparent to permit at least a portion of visible light and/or near infrared light to pass through the portion of the display. The display screen 22 may be rendered transparent for visible light or only for near infrared light (such as to allow near infrared light emitted by the near infrared light emitters to pass through the display screen), depending on the particular application (e.g., whether the camera is capturing color images or near infrared images).

With the DMS camera 18 disposed in the mirror head 12, the camera 18 moves with the mirror head 12 (including the mirror casing and mirror reflective element that pivot at a pivot joint that pivotally connects the mirror head to the mounting structure of the interior rearview mirror assembly that in turn mounts at a windshield or at a headliner of the equipped vehicle), such that, when the driver aligns the mirror to view rearward, the camera 18 is aligned with the line of sight of the driver. The location of the DMS camera 18 and IR LED(s) 20 at the mirror head 12 provide an unobstructed view to the driver. The DMS preferably is self-contained in the interior rearview mirror assembly and thus may be readily implemented in a variety of vehicles, including existing vehicles and different models of the same vehicle brand (for example, in a BMW 3-series model and in a BMW X3 model and in a BMW 5-series model and in a BMW X5 model and in a BMW 7-series model, etc.). The driver monitoring camera may also provide captured image data for an occupancy monitoring system (OMS) or another separate camera may be disposed at the mirror assembly for the OMS function.

The mirror assembly includes a printed circuit board (PCB) having a control or control unit including electronic circuitry (disposed at the circuit board or substrate in the mirror casing), which includes driver circuitry for controlling dimming of the mirror reflective element. The circuit board (or a separate DMS circuit board) includes a processor that processes image data captured by the camera for monitoring the driver and determining, for example, driver attentiveness, driver drowsiness and/or a driver gaze direction. The driver monitoring system includes the driver monitoring camera 18 and may also include an occupant monitoring camera (or the driver monitoring camera may have a sufficiently wide field of view so as to view the occupant or passenger seat of the vehicle as well as the driver region), and may provide occupant detection and/or monitoring functions as part of an occupant monitoring system (OMS).

The mirror assembly may also include the one or more infrared (IR) or near infrared light emitters 20 (such as IR or near-IR light emitting diodes (LEDs) or vertical-cavity surface-emitting lasers (VCSEL) or the like) disposed at the back plate behind the reflective element 16 and emitting near infrared light through the aperture of the back plate and through the reflective element toward the head region of the driver of the vehicle. The IR emitter device includes an IR emitter or LED printed circuit board, with a first set of near infrared light emitting diodes (e.g., a set of wider beam LEDs) at one part of the LED PCB and a second set of near infrared light emitting diodes (e.g., a set of narrower beam LEDs) at another part of the LED PCB. The LED PCB has one part angled relative to the other part to emit light in a desired direction depending on the orientation of the mirror head. For example, the first set of near infrared light emitting diodes 20a may be angled relative to the mirror reflective element 16 so that, with the mirror assembly mounted at a center region of the interior portion of the vehicle, the first set of near IR LEDs 20a emit light that is directed toward the left side of the vehicle. The second set of near IR LEDs 20b may be angled relative to the mirror reflective element to emit light that is directed toward the right side of the vehicle. Further, one or more third sets of near IR LEDs 20c may be positioned and/or angled relative to the mirror reflective element 16 to emit light that is directed toward the center region of the vehicle or for a wide field of illumination. Thus, the first set of near infrared light emitting diodes 20a may be angled toward the left side of the vehicle so as to be directed toward a driver of a left hand drive vehicle (if the mirror assembly is installed in a left hand drive vehicle and the first set of near infrared light emitting diodes are enabled for the driver monitoring function), while the second set of near infrared light emitting diodes 20b may be angled toward the right side of the vehicle so as to be directed toward a driver of a right hand drive vehicle (if the mirror assembly is installed in a right hand drive vehicle and the second set of near infrared light emitting diodes are enabled for the driver monitoring function).

Furthermore, when the mirror assembly is installed in a left hand drive vehicle and the first set of light emitters 20a angled toward the left side of the vehicle are operable to illuminate the driver side of the vehicle for the DMS, the second set of light emitters 20b angled toward the right side of the vehicle may be operable to illuminate the passenger side of the vehicle for an OMS. Similarly, when the mirror assembly is installed in a right hand drive vehicle and the second set of light emitters 20b angled toward the right side of the vehicle are operable to illuminate the driver side of the vehicle for the DMS, the first set of light emitters 20a angled toward the left side of the vehicle may be operable to illuminate the passenger side of the vehicle for the OMS.

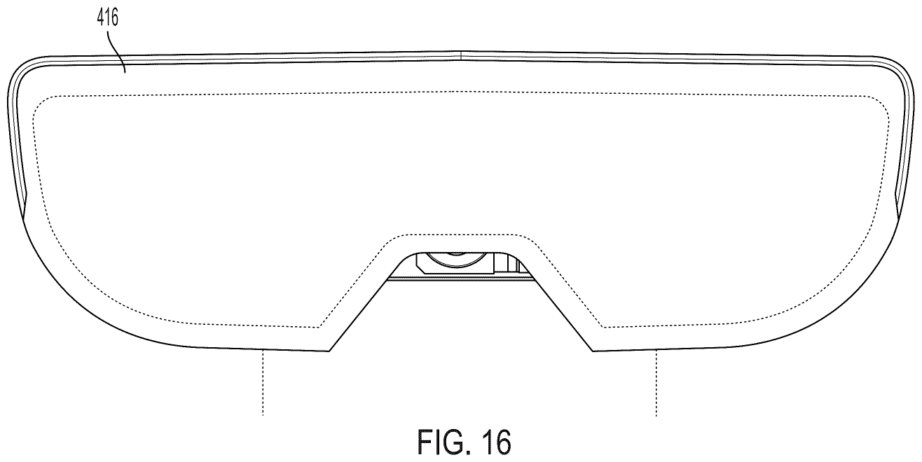

The mirror assembly is designed to provide the camera 18 and near infrared light emitters 20 at the mirror head with minimal intrusion or encroachment on the active display area 22 of the full mirror video display screen. In other words, the size of the video display screen 22, or the relative proportion of the video display screen 22 at the mirror head, is maximized. As shown in FIGS. 1-13, the camera 18 may be disposed at a location that is behind a front glass substrate 24 of the electrochromic mirror reflective element and within a cutout region 28 of the rear glass substrate 26 and the video display screen 22 so that the camera 18 is not at the active EC region and not at the display screen. The camera 18 may be disposed at a side region of the mirror head or at a chin region 32 (e.g., FIG. 16) below the display screen 22, depending on the particular application of the mirror assembly and driver monitoring system.

That is, the rear glass substrate 26 and/or the video display screen 22 include respective recesses or notches or cutouts that overlap or align with one another and define the cutout region 28 at which the camera 18 is disposed. Furthermore, the light emitters 20 may be disposed at or behind or within the respective apertures or cutout regions in the rear glass substrate 26 and/or the video display screen 22 so that the light emitters emit light through the front glass substrate 24 that is not occluded or reflected or interfered with by the rear glass substrate 26 and/or video display screen 22.

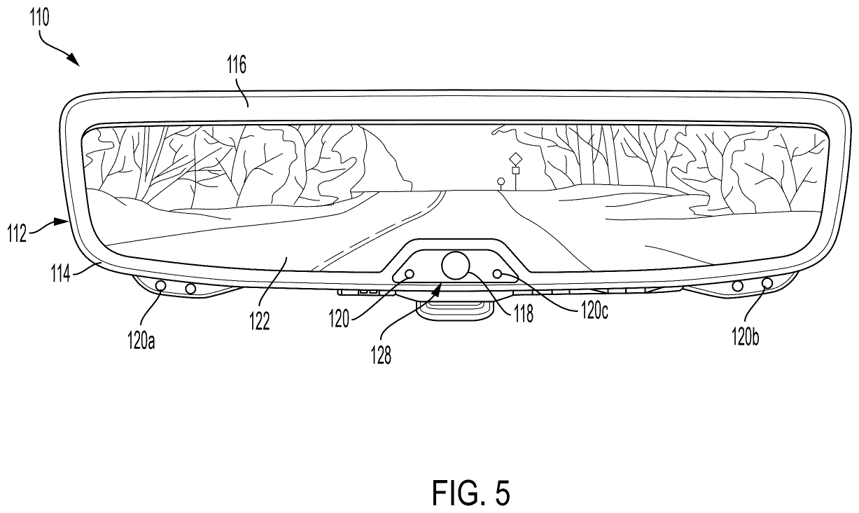

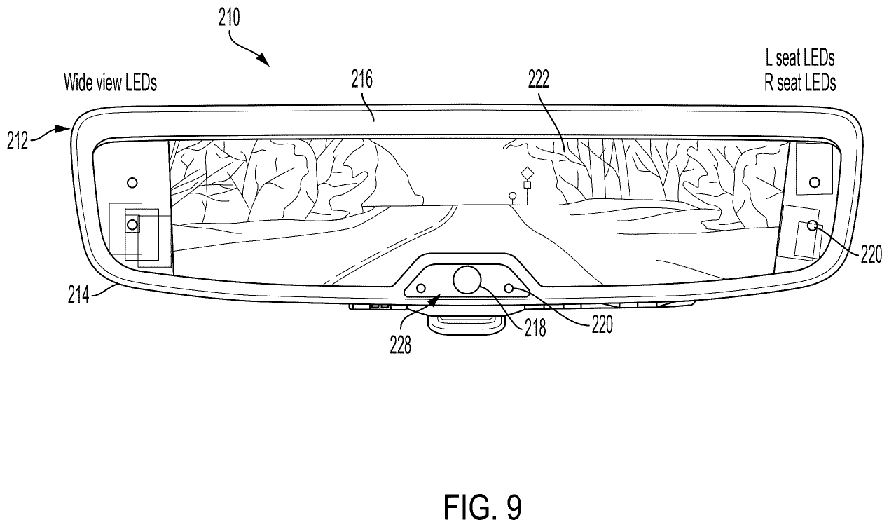

The light emitters 20 may be disposed along an upper region of the mirror head (e.g., FIGS. 1-4) or at a lower region (e.g., FIGS. 5-8) or at side regions (e.g., FIGS. 9-12), depending on the particular application. The light emitters 20 may have angled reflectors to direct or guide the light emitted by the light emitters (when electrically powered) toward the driver or passenger region. The light emitters may be otherwise disposed at the mirror head and may utilize light pipes or light guiding elements to guide or direct the light to emit from the desired or appropriate location at the mirror head when the light emitters are electrically powered. The light pipe may include a fiber optics light pipe with a light concentrator that directs the light toward the targeted region.

Referring to FIGS. 1-4, the first light emitters 20a may be disposed at a first cutout region 28a at an upper corner region of the mirror and along a first side of the mirror (e.g., the left side in FIG. 1, and the side of the mirror nearest the driver side of a left hand drive vehicle when the mirror is installed at the vehicle). The second light emitters 20b may be disposed at a second cutout region 28b at an upper corner region of the mirror and along a second side of the mirror (e.g., the right side in FIG. 1 and the side of the mirror nearest the passenger side of a left hand drive vehicle when the mirror is installed at the vehicle). The third light emitters 20c and the camera 18 may be disposed at a third cutout region 28c at a center region of the mirror and along a lower edge of the mirror. The front glass substrate 24 is disposed over and along the camera 18, the light emitters 20, and the cutout regions.

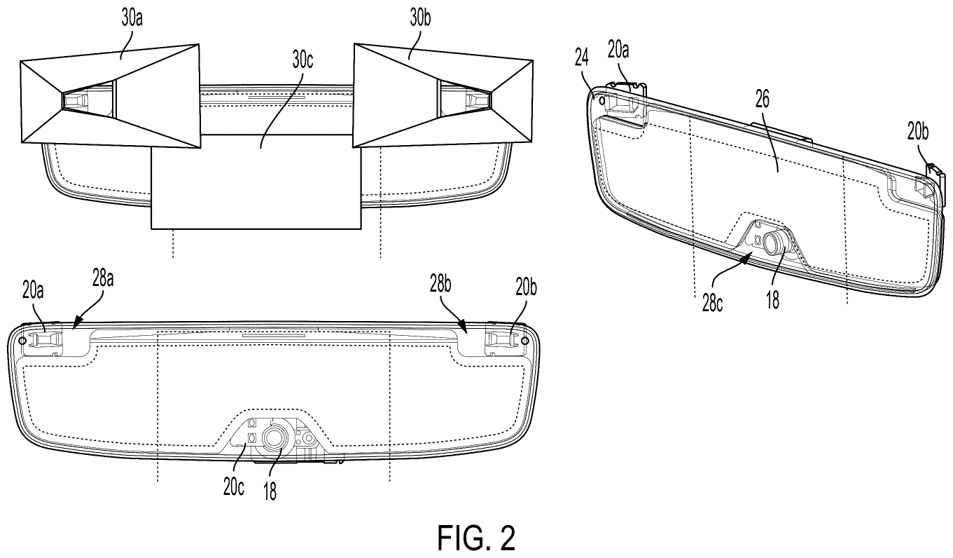

As shown in FIG. 2, respective cones or arrays represent a field of illumination for light emitted by each of the light emitters 20. The first light emitter 20a emits light from the first side of the mirror and in a first field of illumination 30a directed toward the second side of the mirror. That is, the first light emitter 20a may be disposed at the side of the mirror closest to the driver side of a left hand driving vehicle and has the first field of illumination 30a directed toward the passenger side of the vehicle cabin. Similarly, the second light emitter 20b emits light from the second side of the mirror and in a second field of illumination 30b directed toward the first side of the mirror. In other words, the second light emitter 30b disposed at the side of the mirror closest to the passenger side of a left hand driving vehicle has the second field of illumination 30b directed toward the drive side of the vehicle cabin. The third light emitter 20c emits light in a third field of illumination 30c directed toward the center region of the vehicle cabin.

Furthermore, the respective light emitters may emit light in any suitable direction relative to the mirror assembly. For example, because the mirror assembly is mounted at or near an upper surface at the interior portion of the vehicle (e.g., the vehicle headliner or the upper edge region of the vehicle windshield), the light emitters may emit light that is directed at least partially downward. Optionally, the light emitters may emit light sideward and/or upward relative to the mirror assembly. The light emitters may have a narrow field of illumination (e.g., to direct light toward a head region of the driver of the vehicle or a passenger seat position) or a wide field of illumination (e.g., to illuminate a larger area or region of the cabin that may include the rear seat region of the vehicle). Thus, when operated, the light emitters may illuminate any suitable region or portion of the vehicle cabin, including the driver seat, front passenger seat, and one or more rear passenger positions.

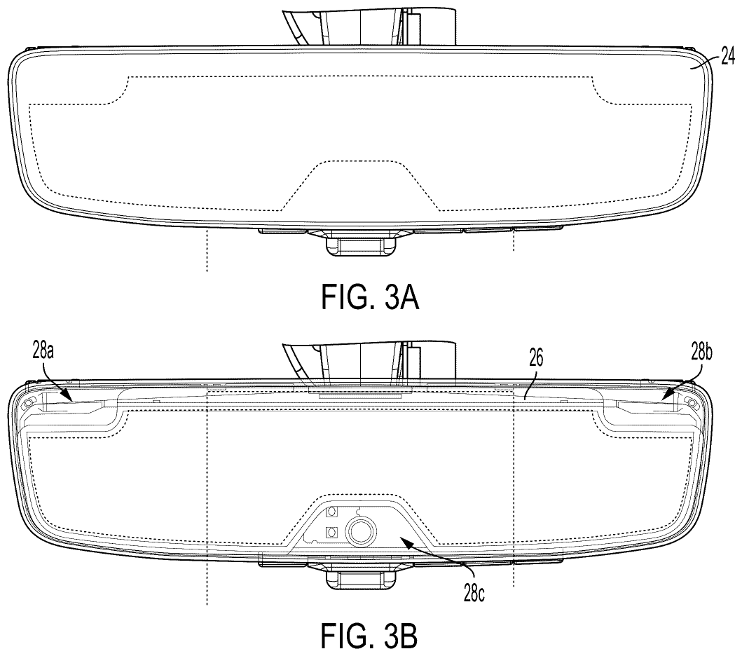

Thus, the rear glass substrate 26 and the video display screen 22 include cutout regions for each of the first light emitter 20a and the second light emitter 20b, and the third light emitter 20c and the camera 18 are disposed at or share the same cutout region. In the illustrated example of FIGS. 1-4, the respective cutout regions are at the respective left and right side upper corner regions of the mirror and along the lower edge at the center region of the mirror. To accommodate the cutouts in the rear glass substrate 26, a shape of the EC active region between the rear substrate 26 and the front substrate 24 also includes cutouts or apertures (e.g., FIGS. 3A and 3B). In other words, the camera 18 and the third light emitter 20c are disposed within the cutout region 28c along the lower edge region of the mirror assembly. The first light emitter 20a is disposed within the cutout region 28a along the upper edge region of the mirror assembly and along the left side (e.g., left in FIG. 2) and may direct light toward the right side of the mirror assembly (e.g., right in FIG. 2). The second light emitter 20b is disposed within the cutout region 28b along the upper edge region of the mirror assembly and along the right side (e.g., right in FIG. 2) and may direct light toward the left side of the mirror assembly (e.g., left in FIG. 2).

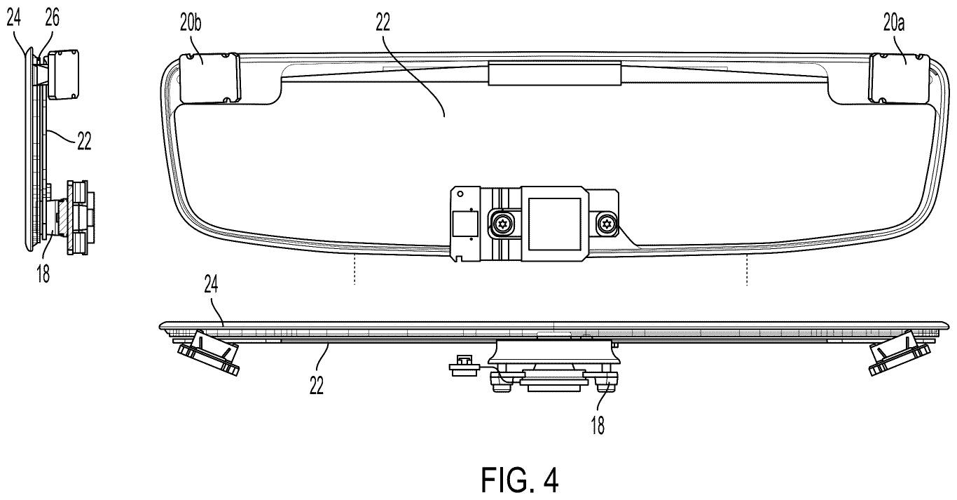

As shown in FIG. 4, a shape of the video display screen 22 generally corresponds to the shape of the rear glass substrate and includes respective cutout regions or apertures that align with the cutout regions 28 accommodating the light emitters 20 and the camera 18. In other words, the video display screen 22 includes corresponding cutout regions that respectively correspond to the cutout region along the lower edge of the rear glass substrate 26 to form the first cutout region 28a, that correspond to the cutout region along the upper edge at the first side of the rear glass substrate 26 to form the second cutout region 28b, and that correspond to the cutout region along the upper edge at the second side of the rear glass substrate 26 to form the third cutout region 28c. The video display screen 22 may extend outside of the EC active region toward the edges of the mirror reflective element.

Referring to FIGS. 5-8, a mirror assembly 110 includes a mirror reflective element 116 with a full video display screen 122 and a camera 118 accommodated by the mirror head 112 of the mirror assembly 110 and viewing through the mirror reflective element 116 to capture image data for the DMS and/or OMS. Near IR light emitters 120 are disposed at a lower region or lower edge of the mirror casing 114 when the mirror assembly 110 is mounted at the interior portion of the vehicle. For example, the near IR light emitters 120 may be disposed below the lower edge of the mirror reflective element 116 or may be disposed so as to emit light through the lower edge region of the mirror reflective element 116. The camera 118 and the near IR light emitters 120 are disposed at a cutout region 128 that extends along the lower edge region of the mirror reflective element 116.

That is, the rear glass substrate 126 and the video display screen 122 each include a respective aperture or recess or cutout region that extends along their respective lower edge regions and that cooperate to define the cutout region 128. The camera 118, the first set of light emitters 120a, the second set of light emitters 120b, and the third set of light emitters 120c may be disposed at the cutout region 128 along the lower edge region of the mirror reflective element 116. Thus, there is not a cutout region at the upper edge region or upper corner regions or side regions of the mirror reflective element and each of the light emitters 120 and the camera 118 are disposed along the lower edge of the mirror head. In other words, the camera 118, the first light emitter 120a, the second light emitter 120b and the third light emitter 120c are disposed within the cutout region 128 along the lower edge region of the mirror assembly.

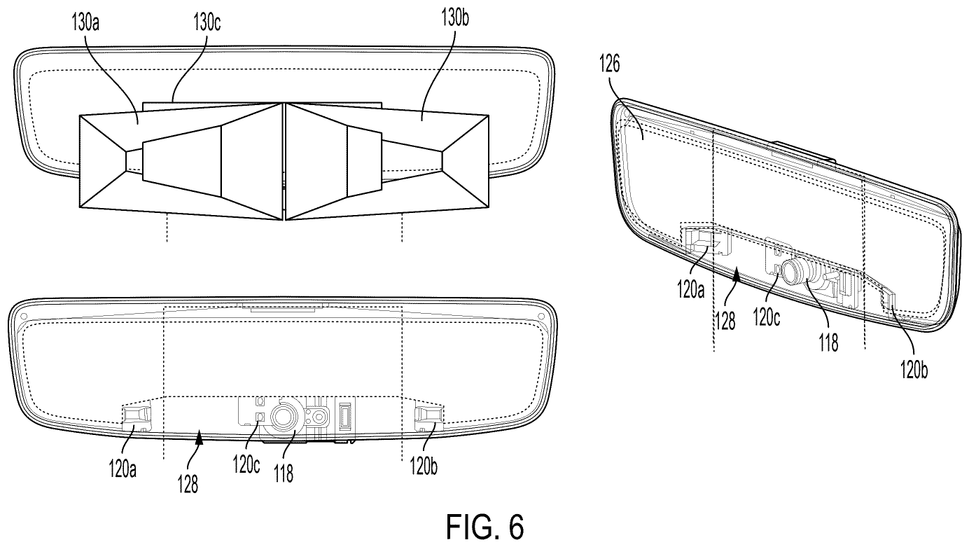

The first light emitters 120a may be disposed at the cutout region 128 and along the first side of the mirror at a first side portion of the cutout region 128 (e.g., the left side in FIG. 6). The second light emitters 120b may be disposed along the second side of the mirror at a second side portion of the cutout region 128 (e.g., the right side in FIG. 6). The third light emitters 120c and the camera 118 may be disposed at the middle or center portion of the cutout region 128. The front glass substrate 124 is disposed over and along the camera 118, the light emitters 120, and the cutout region 128.

As shown in FIG. 6, the first light emitter 120a emits light from the first side of the mirror (e.g., left in FIG. 6) and in a first field of illumination 130a directed toward the second side of the mirror (e.g., right in FIG. 6). The second light emitter 120b emits light from the second side of the mirror and in a second field of illumination 130b directed toward the first side of the mirror. Thus, the first light emitter 120a and the second light emitter 120b direct light toward opposing sides of the vehicle so that the first field of illumination 130a and the second field of illumination 130b cross or overlap when the first light emitter 120a and the second light emitter 120b are electrically operated at the same time. The third light emitter 120c emits light in a field of illumination 130c directed toward the center region of the vehicle cabin.

Optionally, the first light emitter 120a and the second light emitter 120b may direct light toward their respective sides of the vehicle so that their respective fields of illumination do not cross or overlap. That is, with the first light emitter 120a disposed on the first side of mirror nearest the driver side, the first light emitter 120a may direct light toward the driver side of the vehicle, and with the second light emitter 120b disposed on the second side of the mirror nearest the passenger side of the vehicle, the second light emitter 120b may direct light toward the passenger side of the vehicle.

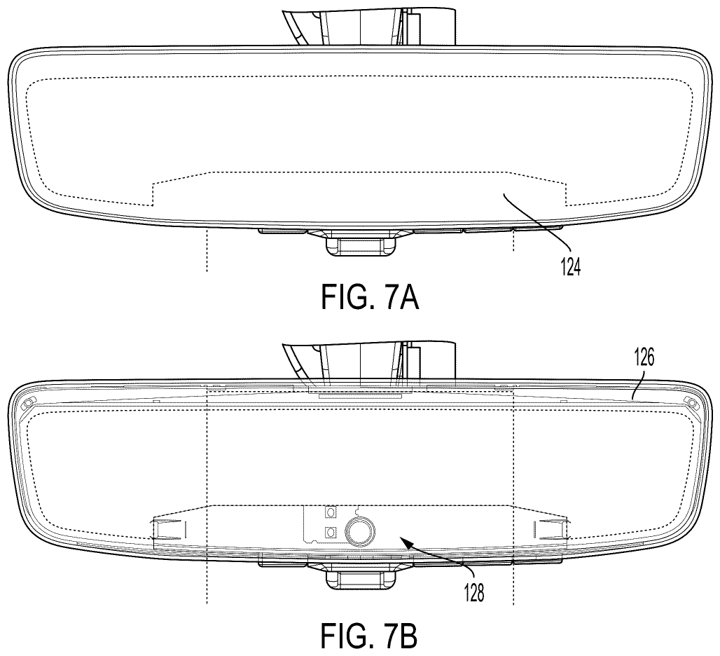

In the illustrated example of FIGS. 5-8, the cutout region 128 extends along the lower edge region of the mirror assembly and thus the first light emitter 120a, the second light emitter 120b, the third light emitter 120c and the camera 118 are all disposed along the same cutout region 128. For example, the single cutout region 128 may simplify the assembly process as the light emitters and camera are positioned relative to a single cutout region rather than separate cutout regions spaced from one another across the mirror assembly. Although the front glass substrate 124 covers the cutout region 128, the EC active region between the rear substrate 126 and the front substrate 124 also includes a cutout or aperture to accommodate the light emitters and the camera (e.g., FIGS. 7A and 7B). Optionally, the respective light emitters and camera may be disposed along the lower edge region of the mirror assembly and at separate, respective cutout regions, such as to increase the relative size of the EC active region and/or video display screen 122 relative to the front glass substrate 124.

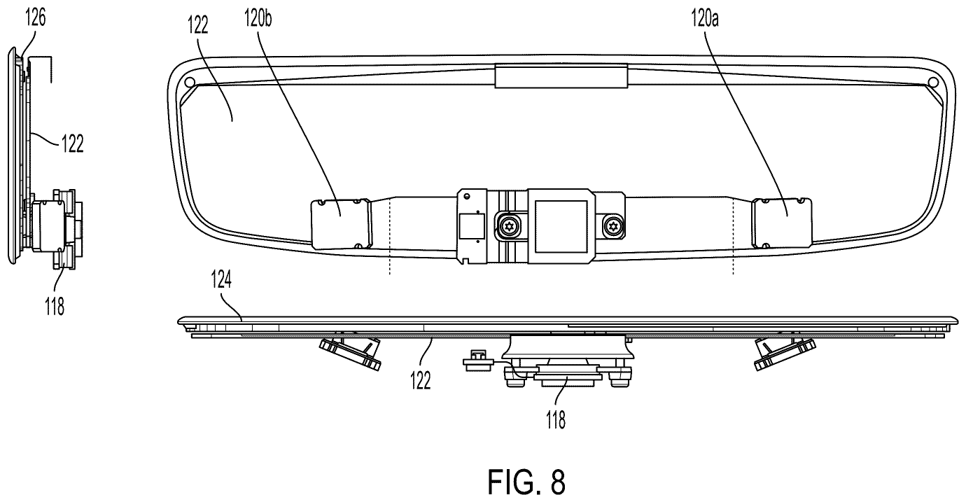

As shown in FIG. 8, a shape of the video display screen 122 generally corresponds to the shape of the rear glass substrate and includes the respective cutout region or aperture that aligns with the cutout region of the rear glass substrate 126 to accommodate the light emitters 120 and the camera 118. In other words, the video display screen 122 includes a corresponding cutout region that respectively corresponds to the cutout region along the lower edge of the rear glass substrate 126 to form the cutout region 128a. The video display screen 122 may extend outside of the EC active region to the edges of the mirror reflective element.

Referring to FIGS. 9-12, a mirror assembly 210 includes a mirror reflective element 216 with a full video display screen 222 and a camera 218 accommodated by the mirror head 212 of the mirror assembly 210 and viewing through the mirror reflective element 216 to capture image data for the DMS and/or OMS. Near IR light emitters 220 are disposed within the mirror casing 216 and behind respective side regions of the mirror reflective element 216, such as along and outboard of opposing edges of the video display screen 222. Thus, the near IR light emitters 220 emit light through the mirror reflective element 216 (and not the video display screen of the mirror reflective element) and from along opposing sides of the mirror assembly. For example, the near IR light emitters at one side of the mirror reflective element (e.g., the right side in FIG. 9) may include a narrow beam set of LEDs for illuminating the driver or left-side seat and another narrow beam set of LEDs for illuminating the passenger or right-side seat, while the near IR light emitters at the other side of the mirror reflective element (e.g., the left side in FIG. 9) may include a wider beam set of LEDs for cabin illumination. The camera 218 and/or one or more additional near IR light emitters are disposed at a cutout region 228 formed along a lower edge region of the mirror reflective element 216. The near IR light emitters 220 disposed along the respective sides of the mirror assembly may be disposed at respective cutout regions formed along the respective sides of the mirror reflective element 216, or the respective outer edges of the video display screen 222 and rear glass substrate 226 may be inboard of the near IR light emitters 220 relative to the front glass substrate 224.

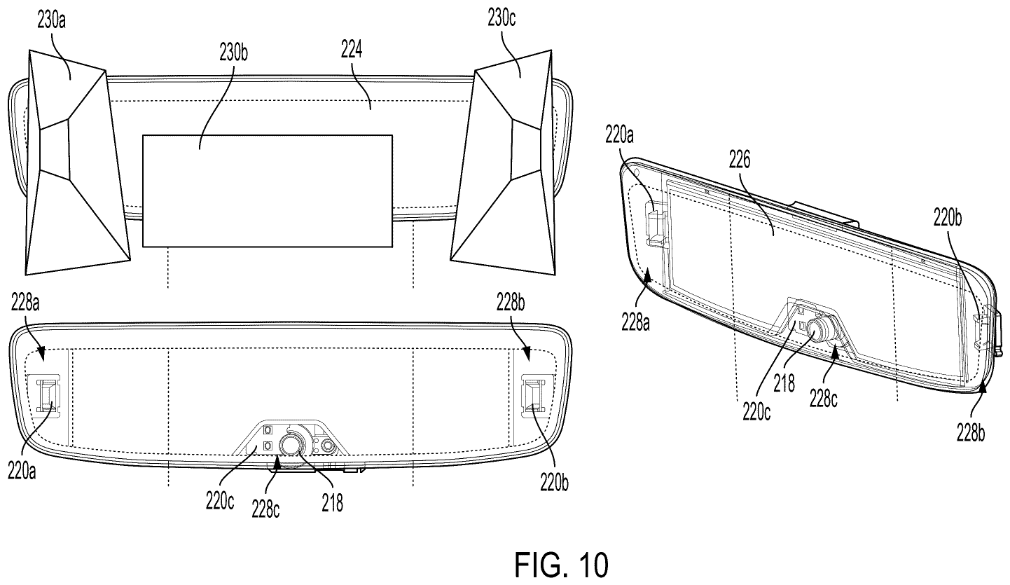

As shown in FIG. 10, respective first lateral edges of the rear glass substrate 226 and the video display screen 222 are aligned within the mirror casing 214 and spaced from a peripheral edge of the mirror casing 214 to define a first cutout region 228a along a first side of the mirror assembly (e.g., left in FIG. 10). Opposite, second lateral edges of the rear glass substrate 226 and the video display screen 222 are aligned and spaced from the peripheral edge of the mirror casing 214 to define a second cutout region 228b along a second side of the mirror assembly (e.g., right in FIG. 10). Furthermore, the rear glass substrate 226 and the video display screen 222 each include a respective aperture or recess or cutout region that extends along their respective lower edge regions and that cooperate to define a third cutout region 228c along the lower edge region of the mirror reflective element 216. The front glass substrate 224 extends over and along the first cutout region 228a, the second cutout region 228b, and the third cutout region 228c.

A first light emitter 220a is disposed at the first cutout region 228a along the first side of the mirror assembly and emits light in a first field of illumination 230a directed toward the second side of the mirror. Thus, the first light emitter 220a may be disposed at the side of the mirror that is closer to the driver side of a left hand driving vehicle and has the first field of illumination 230a directed toward the passenger side of the vehicle. A second light emitter 220b is disposed at the second cutout region 228b along the second side of the mirror assembly and emits light in a second field of illumination 230b directed toward the first side of the mirror. Thus, the second light emitter 220b may be disposed at the side of the mirror that is closer to the passenger side of a left hand driving vehicle and has the second field of illumination 230b directed toward the driver side of the vehicle. A third light emitter 230c and the camera 218 are disposed in the third cutout region 228c along the lower edge of the mirror assembly and the third light emitter 230c directs light toward a central region of the vehicle cabin.

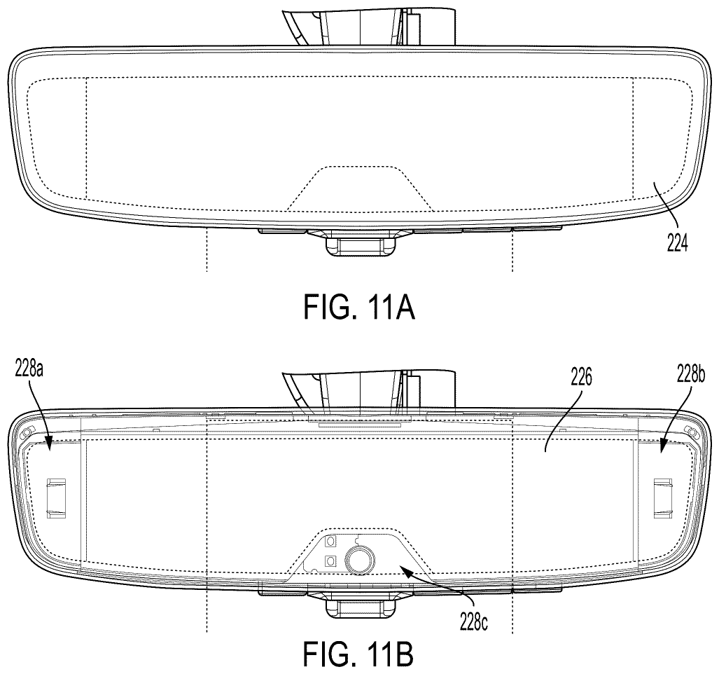

Thus, the rear glass substrate 226 and the video display screen 222 comprise cutout regions for each of the first light emitter 220a and the second light emitter 220b, and the third light emitter 220c and the camera 218 are disposed at or share the cutout region 228c. A shape of the EC active region between the rear glass substrate 226 and the front glass substrate 224 corresponds to the shape or profile of the rear glass substrate 226 (e.g., FIGS. 11A and 11B).

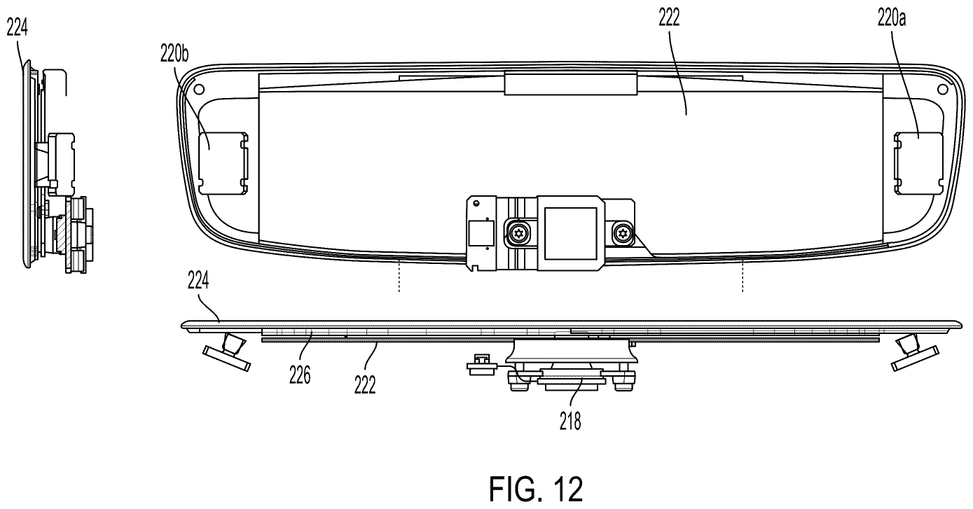

As shown in FIG. 12, a shape of the video display screen 222 generally corresponds to the shape of the rear glass substrate and includes respective cutout regions or apertures that align with the cutout regions 228 accommodating the light emitters 220 and the camera 218. In other words, the video display screen 222 includes corresponding cutout regions that respectively correspond to the cutout region along the first side of the rear glass substrate 226 to form the first cutout region 228a, and that correspond to the cutout region along the second side of the rear glass substrate 226 to form the second cutout region 228c, and that correspond to the cutout region along the lower edge of the rear glass substrate 226 to form the third cutout region 228c. Optionally, the video display screen 222 includes respective outer edges that align with the respective edges of the rear glass substrate 226 to form the first cutout region 228a and the second cutout region 228b along the respective sides of the mirror assembly 210. The video display screen 222 may extend outside of the EC active region to the edges of the mirror reflective element.

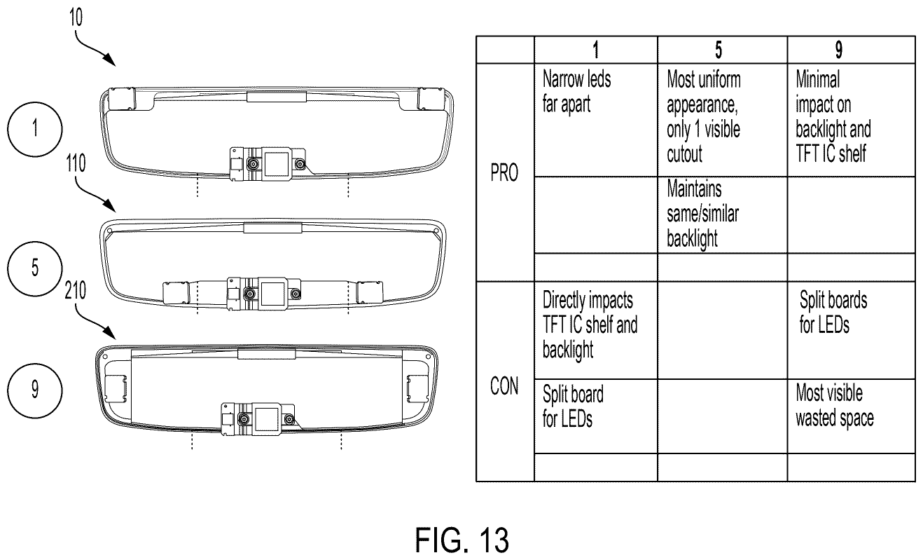

FIG. 13 shows the mirror assembly 10 (FIG. 1), the mirror assembly 110 (FIG. 5), and the mirror assembly 210 (FIG. 9). The mirror assembly 10 provides narrow light emitters or LEDs 20, and the light emitters 20 are disposed far apart from one another (i.e., at opposing sides of the mirror assembly 10) and along the upper edge of the mirror reflective element 16. However, the position of the light emitters 20 of the mirror assembly 10 may directly impact the thin film transistor (TFT) integrated circuit (IC) shelf and the backlight, and may require a split PCB for the LEDs. That is, the light emitters 20 may be disposed at separate PCBs or at a split PCB. The mirror assembly 110, with the light emitters 120 disposed in the cutout region 228 along the lower edge region of the mirror reflective element 216 provides a uniform appearance with only one visible cutout and maintains the same or similar backlight. Furthermore, the mirror assembly 210, with the camera 218 disposed along the lower cutout region 228c and the light emitters 220 disposed along respective sides of the video display screen 222 provides minimal impact on the backlight and the TFT IC shelf. However, the mirror assembly 210 may include a split PCB for the LEDs and may have visible wasted space (i.e., the display screen 222 does not extend to the outer lateral edges of the mirror reflective element 216).

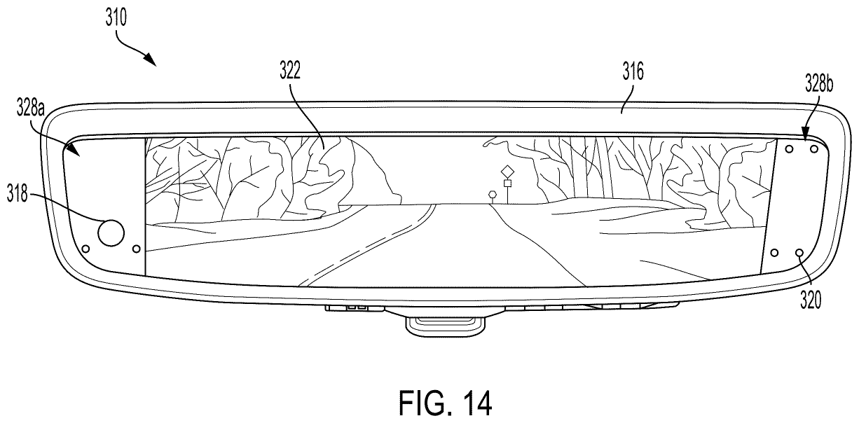

As shown in FIG. 14, a mirror assembly 310 may include the camera 318 disposed within or along one of the first cutout region 328a and the second cutout region 328b along the respective sides of the video display screen and the mirror assembly may not include the third cutout region along the lower edge of the mirror assembly so that the rear glass substrate and the video display screen 322 may extend continuously along the lower edge of the mirror reflective element 316 without a notch or cutout. For example, the camera 318 may be disposed at one of the first and second cutout region based on whether the mirror assembly is installed in a left hand or right hand drive vehicle. The light emitters 320 may be disposed at the first cutout region 328a and/or the second cutout region 328b.

FIG. 15 shows the mirror reflective element 16 with the cutout region 28 along the lower edge of the mirror reflective element. The mirror reflective element 16 has a video display screen and an EC active region with a height (i.e., the dimension measured from a lower edge of the video display screen and/or EC active region to the upper edge of the video display screen and/or EC active region when the mirror reflective element is installed at the vehicle) at a central region of the mirror reflective element 16 that is less than the height of the video display screen and EC active region at the sides of the mirror reflective element. That is, the video display screen and the EC active region of the mirror reflective element has a narrower or smaller dimension at a central region of the mirror reflective element 16 than at the sides, due to the cutout out region at the central region of the mirror reflective element. For example, the height of the video display screen at the central portion of the mirror reflective element 16 may be 30 millimeters, 40 millimeters, 45 millimeters, and the like. The height of the cutout region 28 may be any suitable measurement, such as 18 millimeters, 25 millimeters, and the like, with the lower edge of the cutout region aligned with the lower edge of the mirror reflective element.

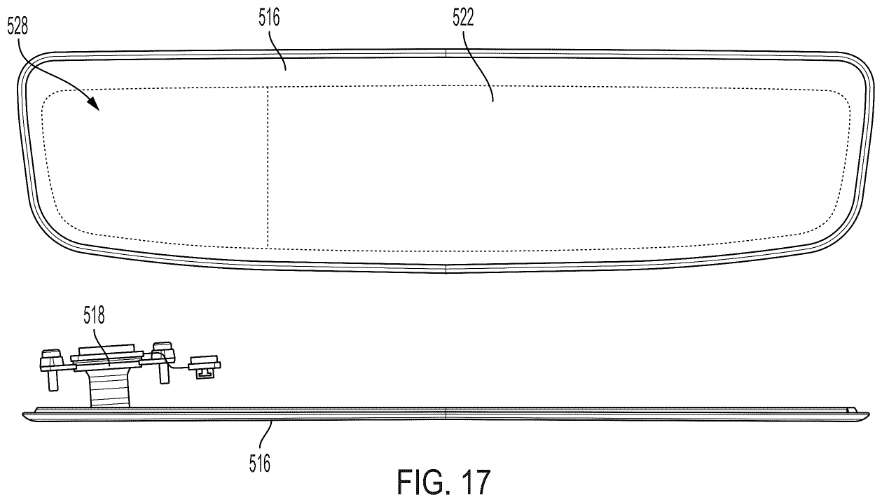

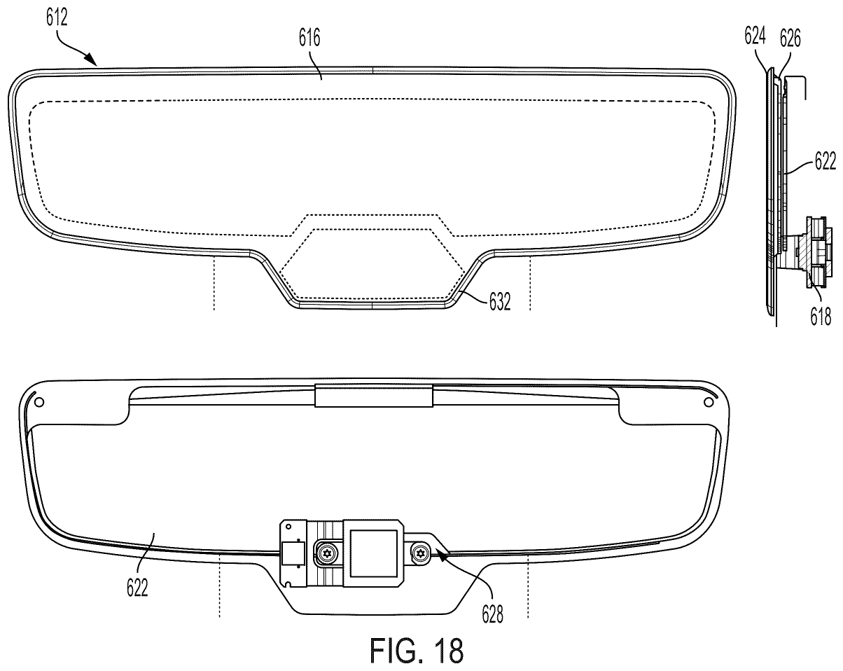

In some examples, it may be desirable to have a minimum height of the EC active region and/or video display screen of, for example, 40 millimeters, 50 millimeters, and the like, such as to provide a large enough video display screen for viewing by the driver. To achieve a larger height of the EC active region and/or video display screen, the mirror assembly may have a mirror reflective element 416 with a greater height along the side portions of the mirror reflective element (e.g., FIG. 16) so that the central region is larger while still accommodating the cutout region. Optionally, the camera 518 (and optionally one or more near IR light emitters) may be disposed at a cutout region 528 of the mirror reflective element 516 along one side of the mirror reflective element 516 so that the video display screen 522 may be disposed at the other side of the mirror reflective element 516 and extend across substantially the entirety of that side of the mirror reflective element 516 (e.g., FIG. 17). Thus, in FIG. 17, the camera is moved from the central region to a side region of the mirror reflective element so that the height of the mirror reflective element 516 may be unchanged while still accommodating the camera 518. Furthermore, the mirror assembly may have a chin region 632 that extends along and below the lower edge of the mirror reflective element 616 to accommodate the camera at the lower edge of the mirror reflective element without increasing the height of the mirror reflective element along the side portions of the mirror reflective element (e.g., FIG. 18). In other words, the camera is moved downward from the lower edge of the mirror reflective element to accommodate a video display screen with a greater height.

As shown in FIG. 18, the camera 618 may be disposed along a lower region of the mirror head 612 with a chin or downward protrusion 632 of the front glass substrate 624 of the mirror reflective element 616 extending downward to conceal or render covert the camera 618. That is, the mirror assembly 610 includes a mirror head 612 having the chin 632 extending from the lower edge at a central portion of the mirror casing 614 and the chin portion 632 of the mirror head 612 accommodates the camera 618 (and optionally one or more near IR light emitters). With the chin 632 protruding along and/or below the lower edge of mirror reflective element 616, the size of the cutout region 628 formed by the notched regions of the video display screen 622 and the rear glass substrate 626 may be minimized (or the mirror assembly may not have a cutout region) to provide a more continuous video display screen 622 of the mirror reflective element 616. The front glass substrate 624 may extend over and along the cutout region 628 and the chin portion 632 of the mirror head 612 to hide or conceal or render covert the camera 618 viewing through the front glass substrate 624 and/or the light emitter that emits light through the front glass substrate 624.

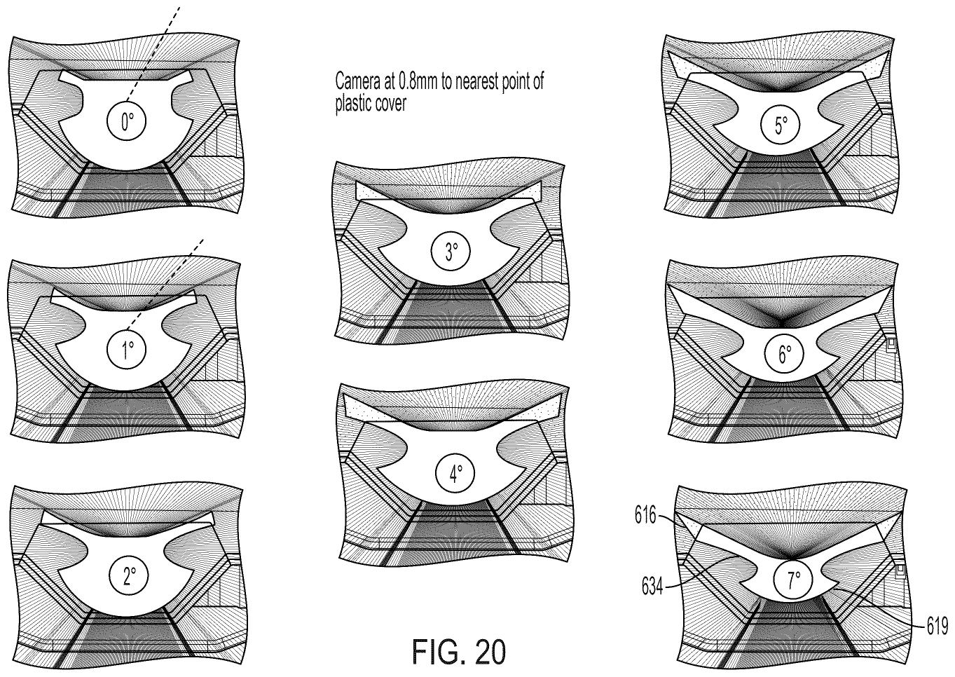

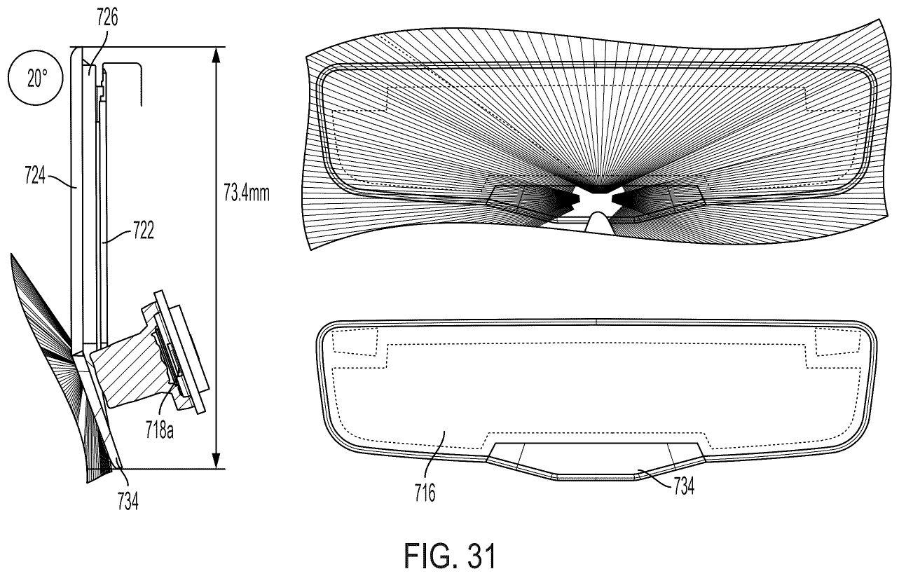

Optionally, the angle of the camera 618 (relative to the front glass substrate 624) may be selected to provide a desired field of view, or a cover panel 634 (such as a transparent or infrared transmitting plastic or acrylic or glass panel) may be disposed in front of the camera 618 and angled to provide the desired field of view (see FIGS. 20-31). Optionally, the camera 618 may be angled downward (e.g., 20 degrees or 25 degrees) and the imager 618a may be shifted upward relative to the lens 618b to provide the desired field of view of the camera. That is, an angle of the imager plane 618a of the camera 618 relative to the rear or inner surface of the mirror reflective element or cover panel 634 may be an oblique angle, such as 1 degree or less, 5 degrees or less, 10 degrees or less, 20 degrees or less, 25 degrees or less, and the like. Tilting the camera yields a smaller vertical requirement for the chin portion and thus the chin may be smaller. The non EC cover panel 634 allows for the camera to be tilted and allows for custom optic elements.

Referring to FIGS. 20-22, the cover panel 634 may include a light transmitting panel (such as an infrared transmitting panel) that allows the camera 618 to view through the cover panel 634 and that hides the camera 618 from view from the driver of the vehicle. The cover panel 634 is disposed at the chin portion 632 and over and along the camera 618 and/or one or more light emitters disposed at the chin 632. Thus, the cover panel 634 may extend from the lower edge of the mirror reflective element 616 with an upper edge of the cover panel 634 adjacent the lower edge of the front glass substrate 624. The cover panel 634 may be at least partially received along the notched or cutout region 628 of the mirror reflective element 616.

The cover panel 634 may be substantially planar and disposed at an oblique angle relative to a plane of the mirror reflective element 616, where the field of view of the camera 618 that views through the cover panel 634 is adjusted based on the angle of the cover panel 634 relative to the mirror reflective element 616 (e.g., FIG. 20). The camera may have a viewing angle that is substantially perpendicular to the plane of the mirror reflective element 616 so that the viewing angle of the camera through the cover panel is substantially equal to the angle of the cover panel 634 relative to the mirror reflective element 616. For example, the cover panel 634 may be disposed at any suitable angle relative to the mirror reflective element 616, such as an angle of the outer surface or plane of the cover panel relative to the an outer surface or plane of the mirror reflective element of 0 degrees, 1 degree, 2 degrees, 3 degrees, 4 degrees, 5 degrees, 6 degrees, 7 degrees, and the like. The camera 618 may be tilted with the cover panel 634 so that the imager plane of the camera 618 is substantially parallel with the cover panel and thus angled relative to the mirror reflective element 616. Optionally, the camera 618 is not tilted with the cover panel 634 such that the imager plane of the camera 618 is substantially parallel with the mirror reflective element 616 and the cover panel 634 is angled relative to the mirror reflective element 616 and the imager plane of the camera 618.

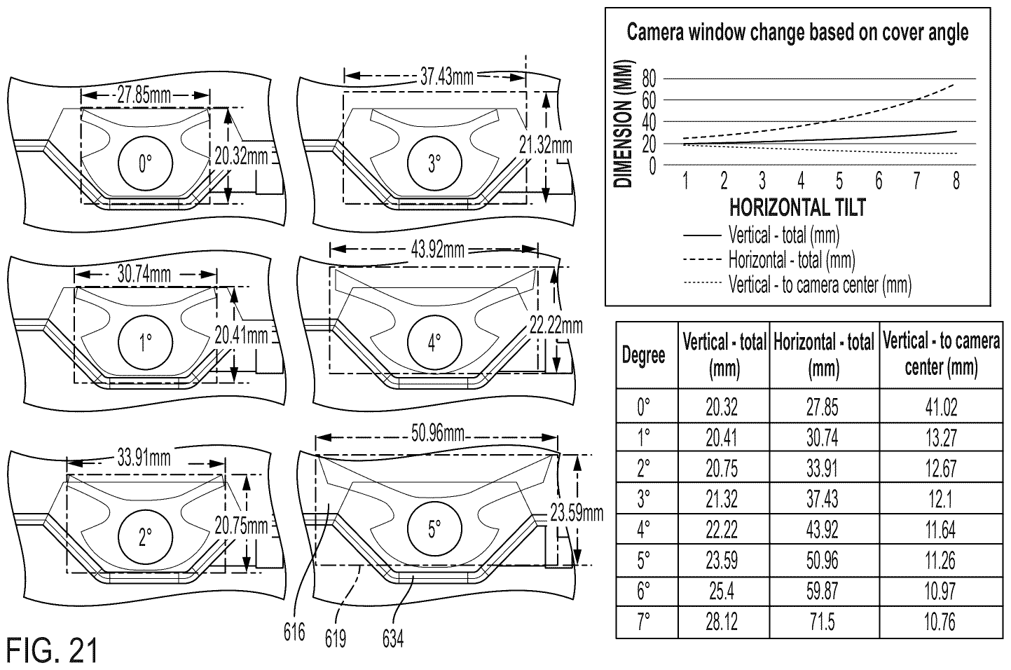

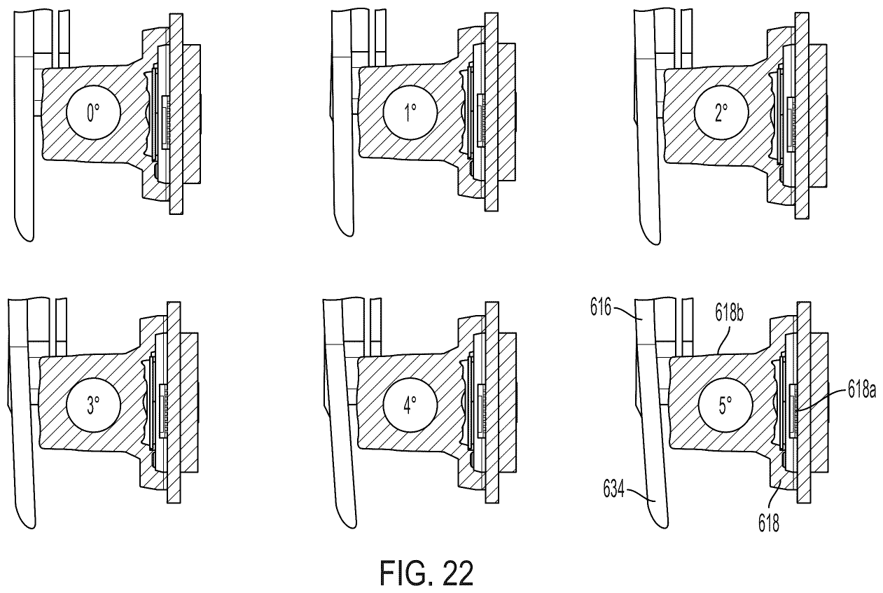

As shown in FIG. 21, as the angle of the cover panel 634 relative to the mirror reflective element 616 and the camera 618 increases, the size of the camera window 619 increases. With the angle of the camera imager 618a and the camera lens 618b constant relative to the mirror reflective element 616, the angle of the cover panel 634 relative to the mirror reflective element 616 adjusts the viewing angle of the imager 618a through the lens 618b and the cover panel 634 (e.g., FIG. 22).

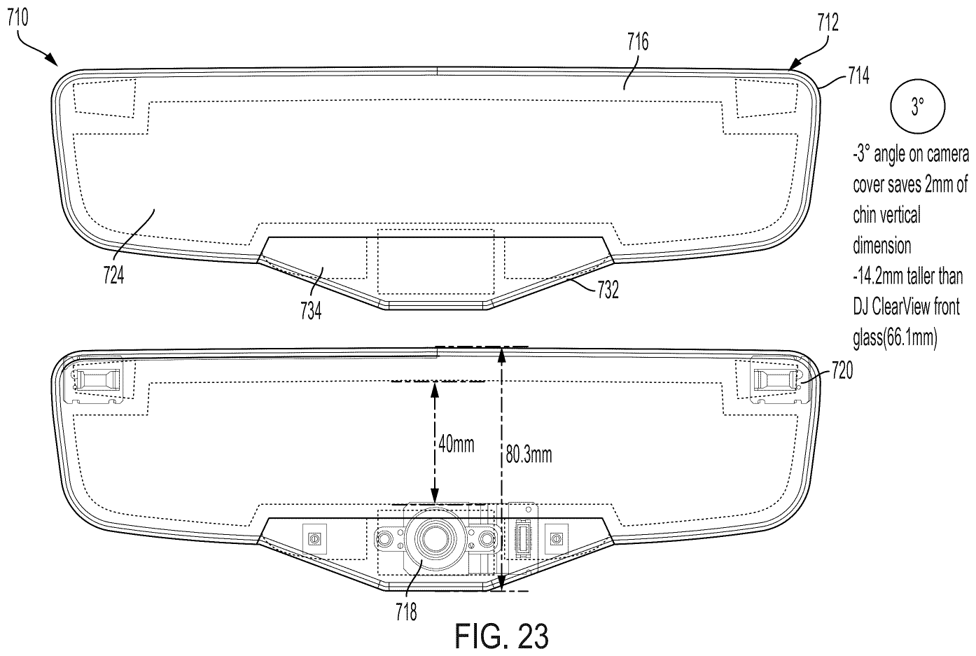

Referring to FIGS. 23-25, a mirror assembly 710 includes a mirror reflective element 716 with a full video display screen 722 and a camera 718 accommodated by the mirror casing 714 at a chin region or portion 732 of the mirror head 712. The camera 718 views through a cover panel 734 disposed over and along the camera 718 at the chin region 732. One or more near IR light emitters 720 are electrically operable to emit light through the cover panel 734 and/or the mirror reflective element 716. In the illustrated example, respective apertures or recesses or notches in the rear glass substrate 726 and the video display screen 722 define cutout regions 728 at the upper corner regions of the mirror reflective element 716 and light emitters are disposed at the respective cutout regions 728 and emit light through the front glass substrate 724. In other words, a cutout region 728 is formed along the upper edge of the mirror reflective element 716 and along a first side of the mirror reflective element and another cutout region 728 is formed along the upper edge of the mirror reflective element 716 and along a second side of the mirror reflective element 716. Each cutout region accommodates near IR light emitters 720. A third cutout region 728 may be formed along the lower edge region of the mirror reflective element 716 for accommodating the camera 718 and the cover panel 734 may be at least partially received along the third cutout region. The cover panel 734 may be angled relative to the mirror reflective element 716 to minimize the extension of the chin 732 below the lower edge of the mirror reflective element 716.

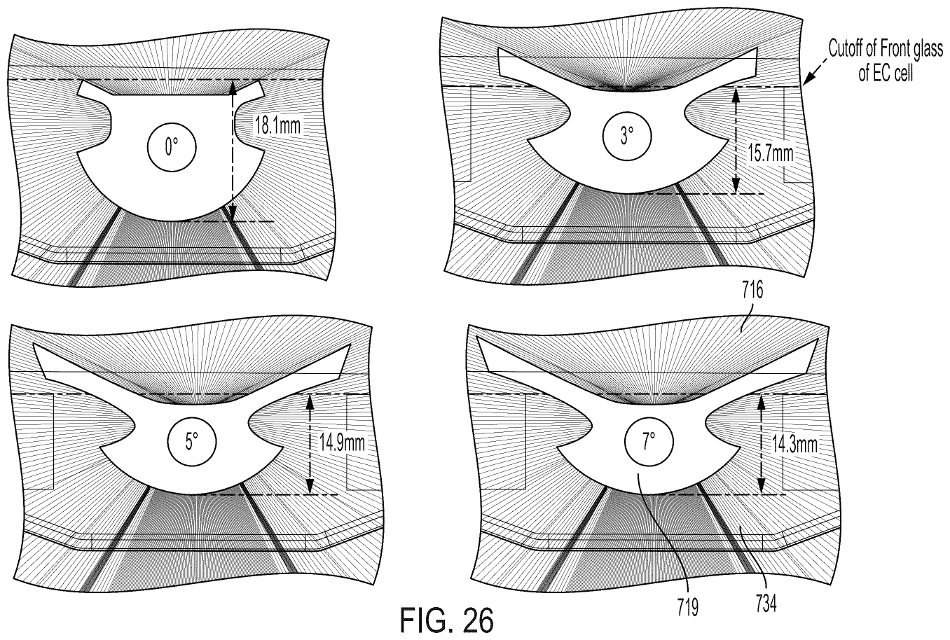

As shown in FIGS. 26-28, the angle of the cover panel 734 relative to the mirror reflective element 716 allows for a shorter or smaller chin 732 as the vertical dimension of the camera viewing window 719 decreases as the angle of the cover panel 734 relative to the mirror reflective element 716 increases. For example, a 3 degree angle of the cover panel 734 relative to the mirror reflective element 716 may save 2 or more millimeters of vertical dimension on the chin 732 so that the mirror head 712 may only be 14.2 millimeters taller than a full video display mirror assembly without the DMS camera.

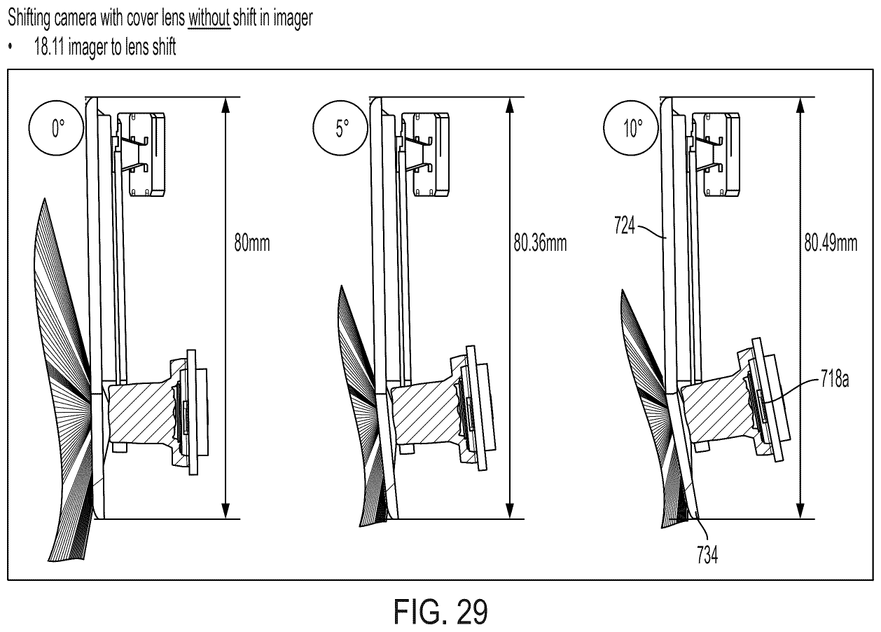

Referring to FIGS. 29-31, the camera 718 and the cover panel 734 may both be angled a substantially equal amount relative to the mirror reflective element 716. Thus, the plane of the imager 718a is substantially parallel to the cover panel 734 and angled relative to the mirror reflective element 716. That is, the principal viewing axis of the camera is substantially normal to the cover panel. For example, the camera 718 and cover panel 734 may be disposed at any suitable angle relative to the mirror reflective element 716, such as 0 degrees, 5 degrees, 10 degrees, 20 degrees, and the like. As the angle of the cover panel 734 and camera 718 relative to the mirror reflective element 716 increases, the vertical dimension of the chin 732 and mirror head decreases.

Optionally, the video display screen may be at least locally rendered transparent (or at least partially transmissive of near IR light), such that the camera and/or light emitters may be disposed behind the portion or region of the video display screen that can be locally rendered transparent so that, when the portion of the video display screen is displaying video images, the camera and/or light emitters are concealed or hidden behind the portion of the mirror reflective element. When the camera needs to view through the mirror reflective element and/or the light emitters need to emit light that passes through the mirror reflective element, the portion of the video display screen may be locally rendered transparent so that light may pass through that portion of the mirror reflective element.

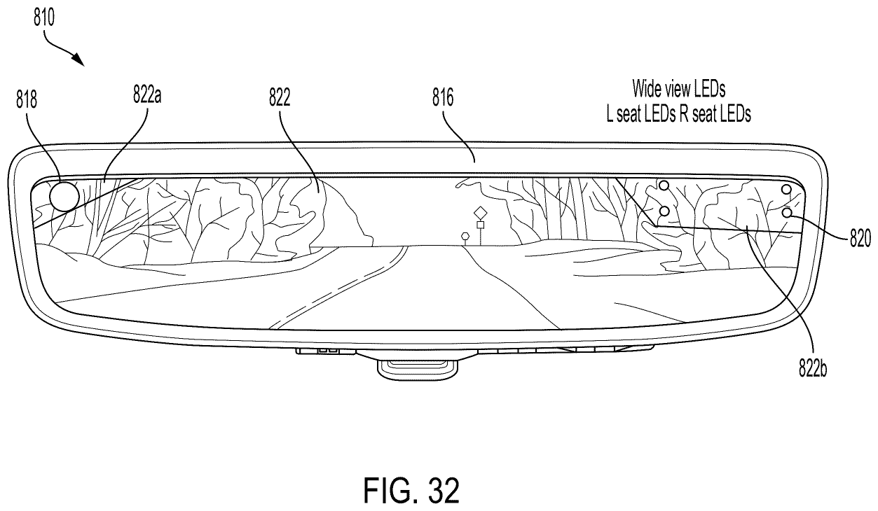

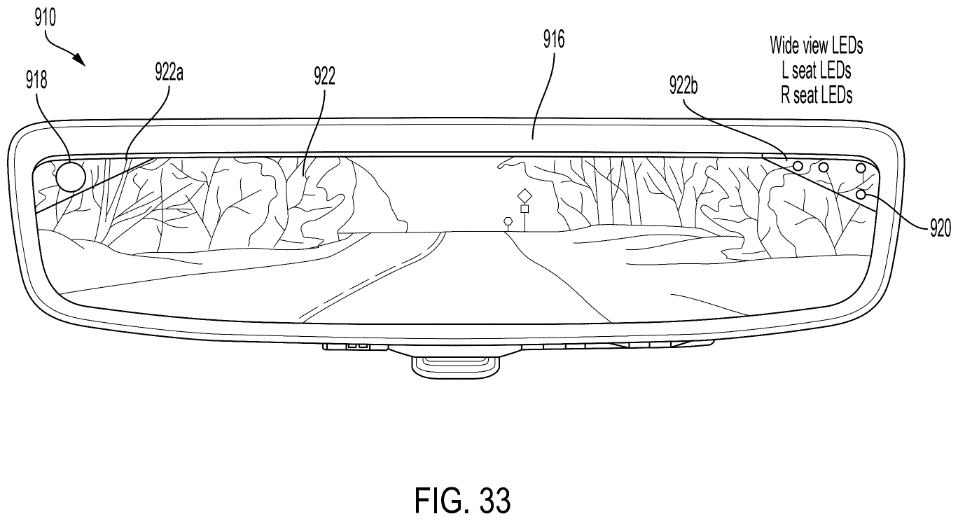

For example, FIG. 32 depicts a mirror assembly 810 having a camera 818 disposed at an upper corner region at a first side of the mirror head and viewing through a first portion 822a of the video display screen 822 of the mirror reflective element 816 that may be locally rendered transparent (or at least partially transmissive of near IR light), and the light emitters 820 are disposed at an upper corner region at a second side of the mirror head and operable to emit light through a second portion 822b of the video display screen 822 that may be locally rendered transparent. FIG. 33 similarly depicts a mirror assembly 910 having a camera 918 disposed at an upper corner region at a first side of the mirror head and viewing through a first portion 922a of the video display screen 922 of the mirror reflective element 916 that may be locally rendered transparent, and the light emitters 920 are disposed at an upper corner region at a second side of the mirror head and operable to emit light through a second portion 922b of the video display screen 922 that may be locally rendered transparent. Thus, the video display screen may span substantially the entirety of the mirror reflective element, such as a proportion of 75 percent or more, 85 percent or more, 95 percent or more, and the like.

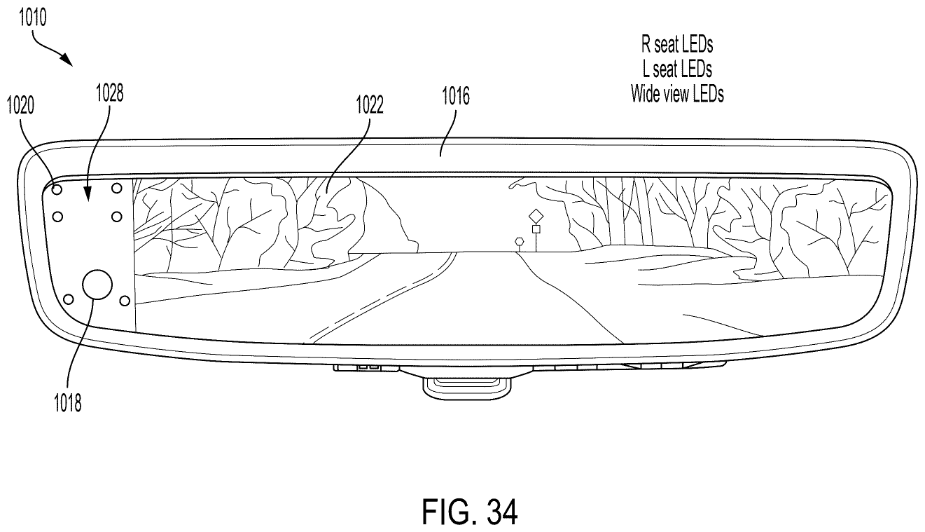

Optionally, the camera and one or more near IR light emitters may be consolidated into one or more cutout regions along the side regions of the mirror head so that the display screen may cover a relatively greater portion of the mirror reflective element. For example, FIG. 34 depicts a mirror assembly 1010 having a mirror reflective element 1016 with a display screen 1022 and rear glass substrate forming a cutout region 1028 disposed along one side of the mirror head (e.g., left in FIG. 34) and the camera 1018 and one or more light emitters 1020 are disposed at the cutout region 1028.

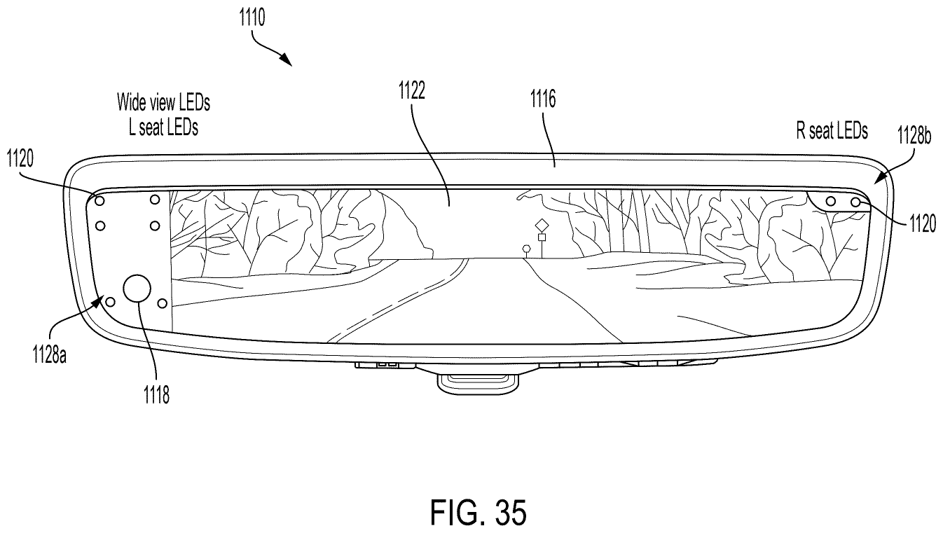

FIG. 35 depicts a mirror assembly 1110 having a mirror reflective element 1116 with a display screen 1122 and rear glass substrate forming a first cutout region 1128a disposed along one side of the mirror head (e.g., left in FIG. 35) and the camera 1118 and one or more light emitters 1120 are disposed at the first cutout region 1128a, and a smaller second cutout region 1128b is formed at a corner region along the other side of the mirror head to accommodate one or more additional light emitters 1120.

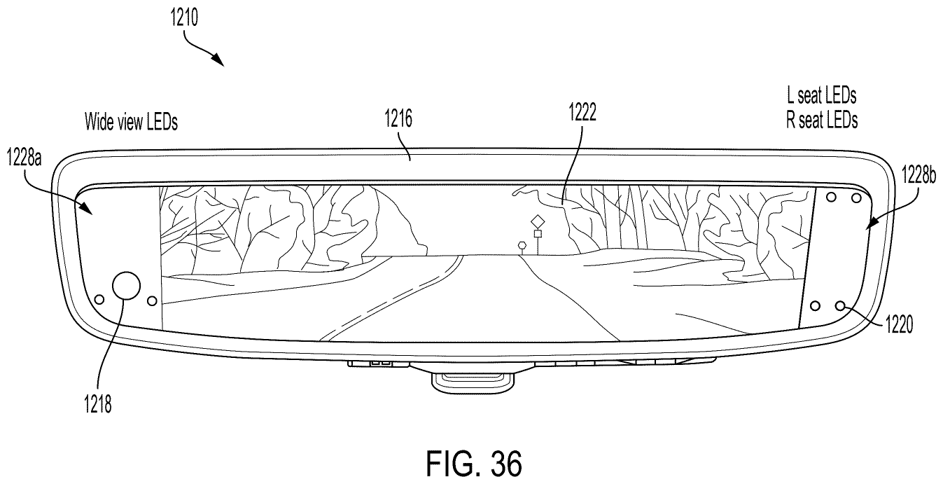

FIG. 36 depicts a mirror assembly 1210 having a mirror reflective element 1216 with a display screen 1222 and rear glass substrate forming a first cutout region 1228a disposed along one side of the mirror head (e.g., left in FIG. 36) to accommodate the camera 1218 and one or more light emitters 1220 and a second cutout region 1228b disposed along the other side of the mirror head (e.g., right in FIG. 36) to accommodate one or more additional light emitters 1220.

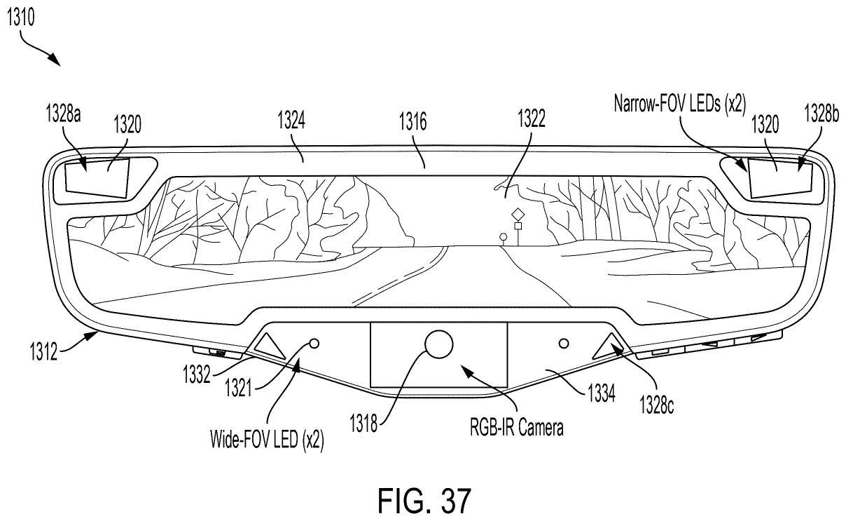

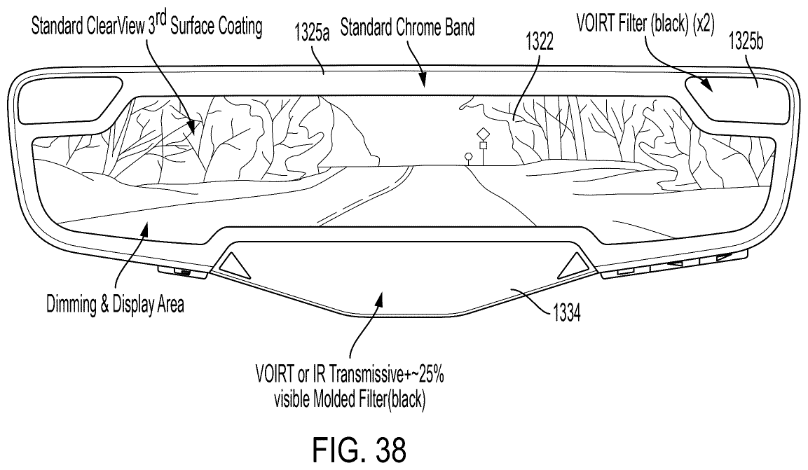

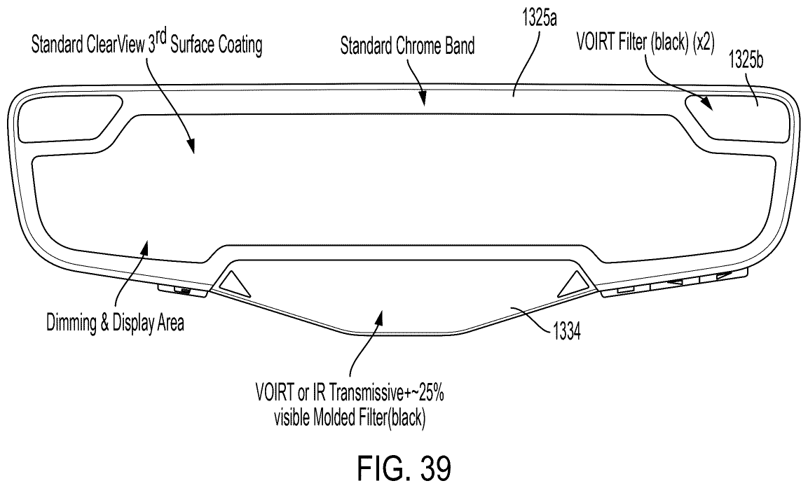

Referring to FIGS. 37-39, a mirror assembly 1310 includes a mirror reflective element 1316 with a full view video display screen 1322 that substantially fills the mirror reflective element 1316 (e.g., the video display screen 1322 covers a proportion of the mirror reflective element 1316 of 75 percent or more, 85 percent or more, 95 percent or more, or the like). Narrow field of view light emitters 1320 are disposed respectively at a first cutout region 1328a at the upper corner region along a first side of the mirror reflective element 1316 (e.g., left in FIG. 37) and at a second cutout region 1328b at the upper corner region along a second side of the mirror reflective element 1316 (e.g., right in FIG. 37). A third cutout region 1328c may extend along the lower edge of the mirror reflective element 1316 to accommodate the camera 1318 along the lower edge of the mirror reflective element 1316. Furthermore, one or more wide field of view light emitters 1321 may be disposed at the third cutout region 1328c.

The front glass substrate 1324 of the mirror reflective element 1316 extends over and along the first cutout region 1328a and the second cutout region 1328 so that the light emitters, when electrically operated, emit light through the front glass substrate 1324. A chrome band 1325a may be disposed at the mirror reflective element (e.g., between the front glass substrate and the rear glass substrate) and circumscribe the video display screen 1322, and an IR light transmissive coating 1325b may be disposed at the mirror reflective element over and along one or more of the cutout regions.

The camera 1318 and the wide field of view light emitters 1321 are disposed at a chin portion 1332 of the mirror head 1312 and a cover panel 1334 (such as an IR light transmissive cover panel) extends over the chin portion 1332 below the mirror reflective element 1316. Thus, the camera 1318 views through the cover panel 1334 and the wide field of view light emitters 1321 emit light through the cover panel 1334. The cover panel 1334 may be coated so as to at least partially block passage of visible light therethrough and to at least partially allow passage of near IR light therethrough to render the camera and light emitters at least partially covert to the driver of the vehicle.

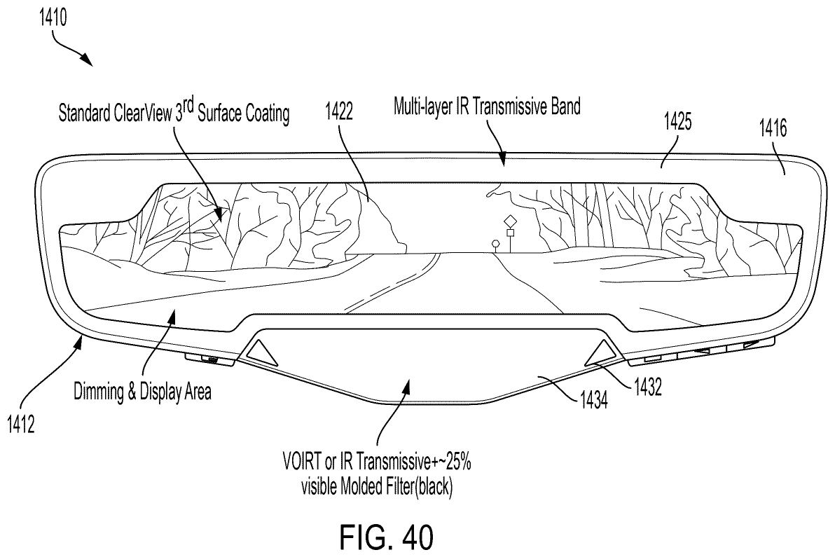

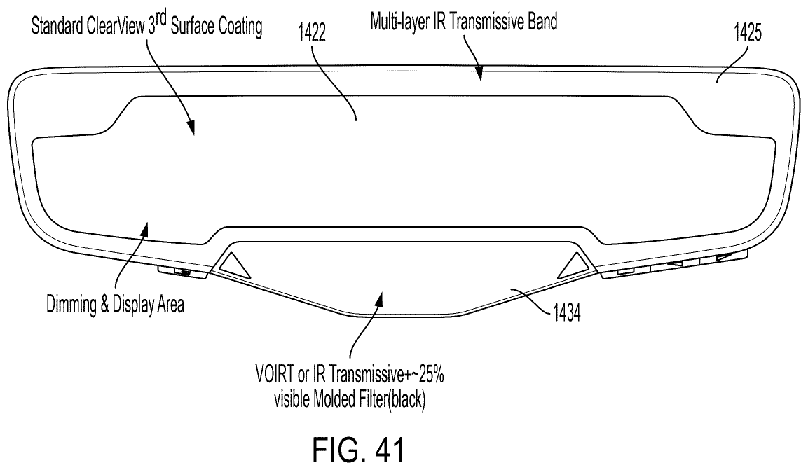

Referring to FIGS. 40 and 41, a mirror assembly 1410 includes a mirror reflective element 1416 with a full view video display screen 1422 that substantially fills the mirror reflective element 1416 (e.g., the video display screen 1422 covers a proportion of the mirror reflective element 1416 of 75 percent or more, 85 percent or more, 95 percent or more, or the like). A chin portion 1432 of the mirror head 1412 extends below the lower edge of the mirror reflective element 1416 to house the camera and/or one or more light emitters. A cover panel 1434 extends over the chin portion 1432 and comprises an IR light transmissive material that permits transmission of IR light and/or near IR light and blocks transmission of visible light (such as about 75 percent or more of visible light) to hide or conceal the camera and/or light emitters. A multi-layer IR transmissive band 1425 is disposed at the mirror reflective element 1416 (such as between the respective glass substrates) and circumscribes the video display screen 1422. One or more IR light emitters are disposed behind the front glass substrate of the mirror reflective element 1416 and outboard of the video display screen 1422, such that the light emitters emit IR or near IR light through the IR transmissive band 1425. The IR transmissive band 1425 hides or conceals the light emitters behind the mirror reflective element 1416.

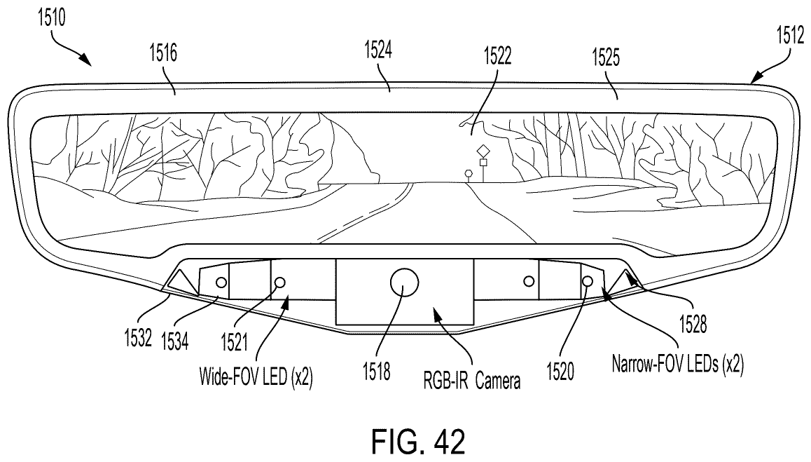

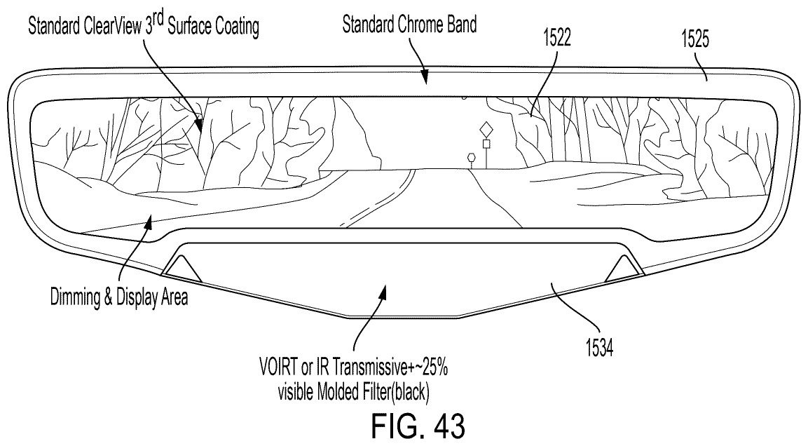

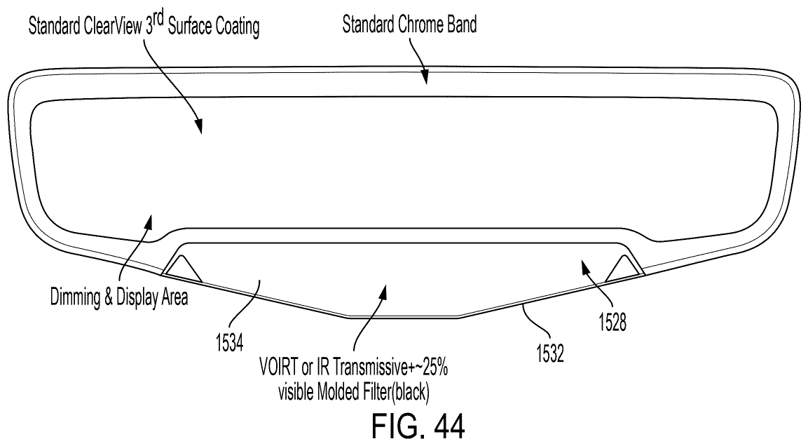

Referring to FIGS. 42-44, a mirror assembly 1510 includes a mirror reflective element 1516 with a full view video display screen 1522 that substantially fills the mirror reflective element 1516 (e.g., the video display screen 1522 covers a proportion of the mirror reflective element 1516 of 75 percent or more, 85 percent or more, 95 percent or more, or the like). A cutout region 1528 extends along a lower edge of the mirror reflective element 1516, with a chin portion 1532 of the mirror head 1512 extending from the cutout region 1528. Narrow field of view light emitters 1520, wide field of view light emitters 1521, and the camera 1518 are accommodated by the camera head 1512 along the cutout region 1528 and within the chin portion 1532.

A chrome band 1525 may be disposed at the mirror reflective element (such as between the front glass substrate and the rear glass substrate) and circumscribes the video display screen 1522. A cover panel 1534 (such as an IR light transmissive cover panel) extends over the chin portion 1532 below the mirror reflective element 1516. Thus, the camera 1518 views through the cover panel 1534 and the narrow field of view light emitters 1520 and the wide field of view light emitters 1521 emit light through the cover panel 1534. The cover panel 1534 may not allow passage of visible light therethrough to render the camera and light emitters at least partially covert to the driver of the vehicle. For example, the cover panel 1534 may be configured to block about 75 percent or more of visible light from passing through the cover panel 1534 while allowing relatively more IR or near IR light to pass through the cover panel 1534.

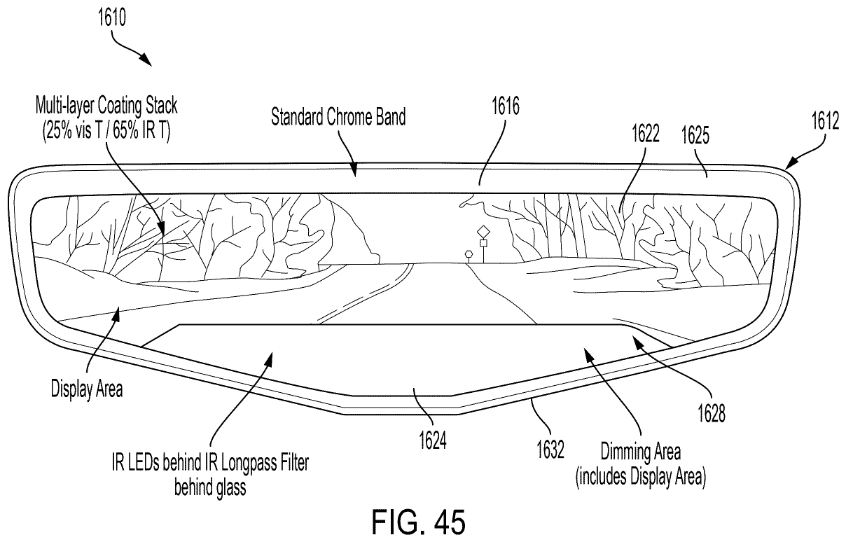

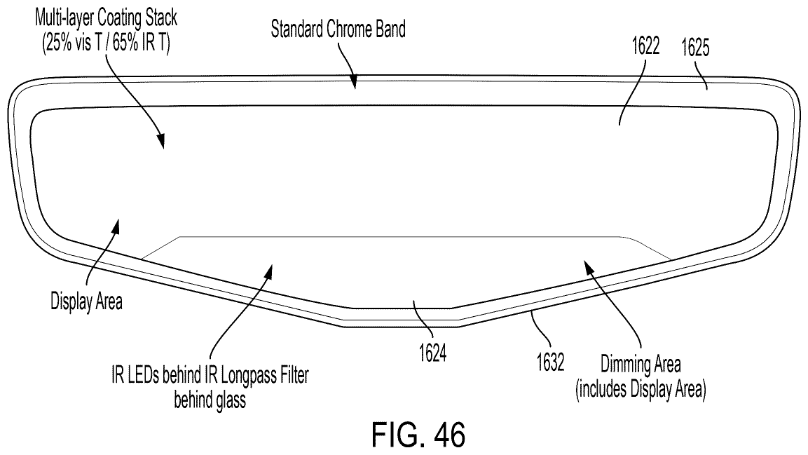

Referring to FIGS. 45 and 46, a mirror assembly 1610 includes a mirror reflective element 1616 having a full video display screen 1622 and a cutout region 1628 that extends along a lower edge of the mirror reflective element 1616. The mirror head 1612 includes a chin portion 1632 that extends below the lower edge of the mirror reflective element 1616 at the cutout region 1628. The chin portion 1632 may accommodate the camera and/or one or more IR or near IR light emitters. As shown, the front glass substrate 1624 may extend along the chin portion 1632 so that the camera and/or one or more light emitters are disposed behind the front glass substrate 1624. The portion of the mirror reflective element 1616 that extends along the chin portion 1632 may be dimmable or darkenable to hide or conceal the components disposed within the chin portion 1632 behind the mirror reflective element 1616. A band (e.g., a chrome band) 1625 may be disposed at the mirror reflective element (such as between the respective glass substrates) and extend along a periphery of the mirror head 1612 (e.g., the video display screen and the chin portion).

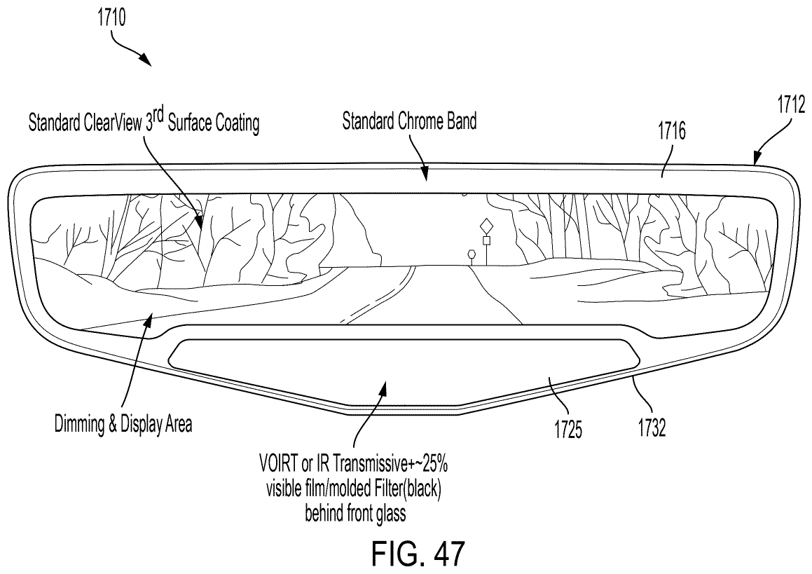

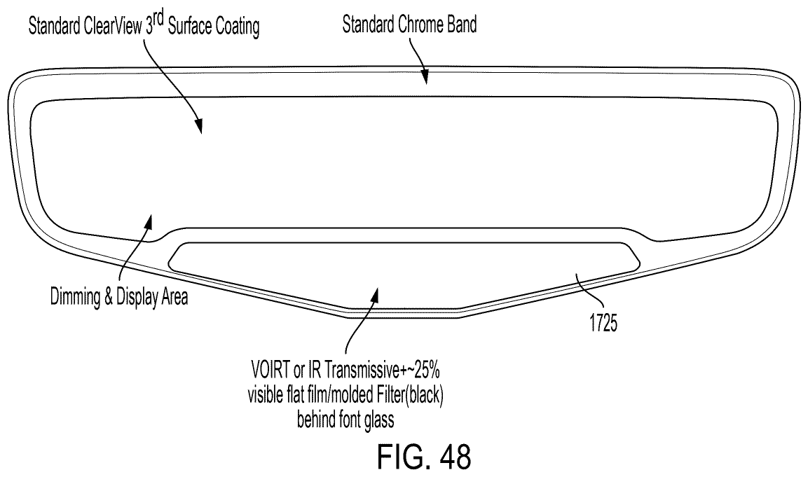

Referring to FIGS. 47 and 48, a mirror assembly 1710 includes a filter medium or coating 1725 over and along the mirror reflective element 1716 at the chin portion 1732 of the mirror head 1712, such as an IR light or near IR light transmissive coating that allows for transmission of IR light and/or near IR light through the coating 1725 and that blocks a substantial portion of visible light incident thereat (such as about 75 percent or more, 85 percent or more, 95 percent or more, or the like) to hide or conceal a camera and/or one or more IR light or near IR light emitters disposed at the chin portion 1732. The coating 1725 may be disposed at the mirror reflective element 1716, such as at the exterior surface of the front glass substrate, or behind the front glass substrate and between the front glass substrate and the rear glass substrate of the mirror reflective element 1716.

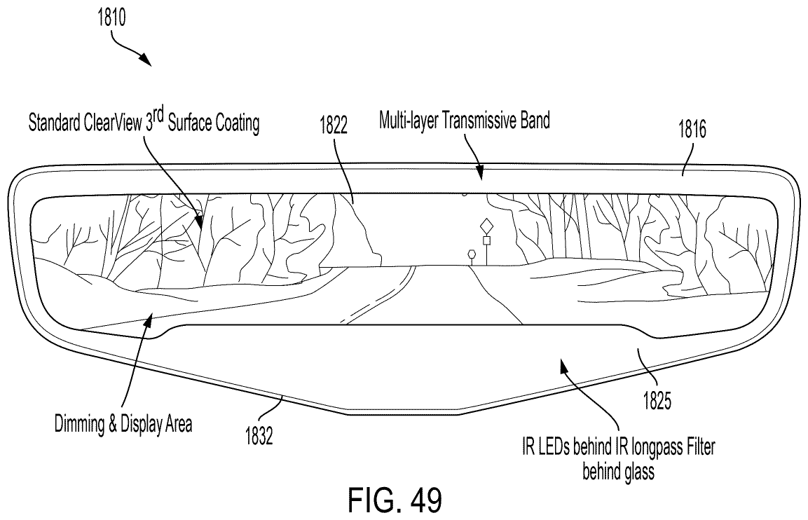

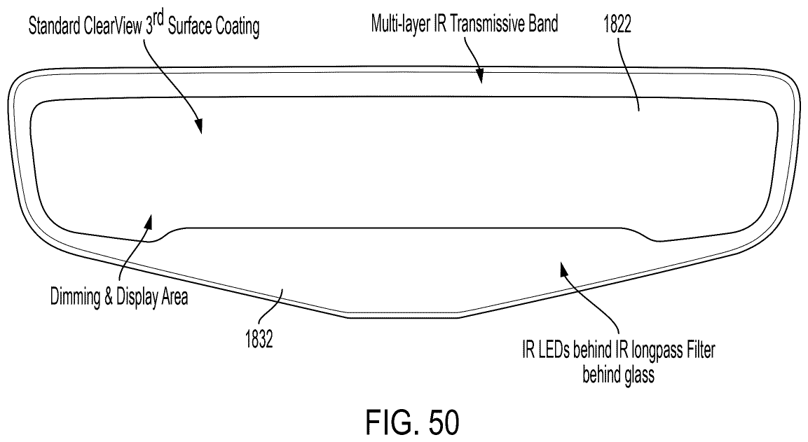

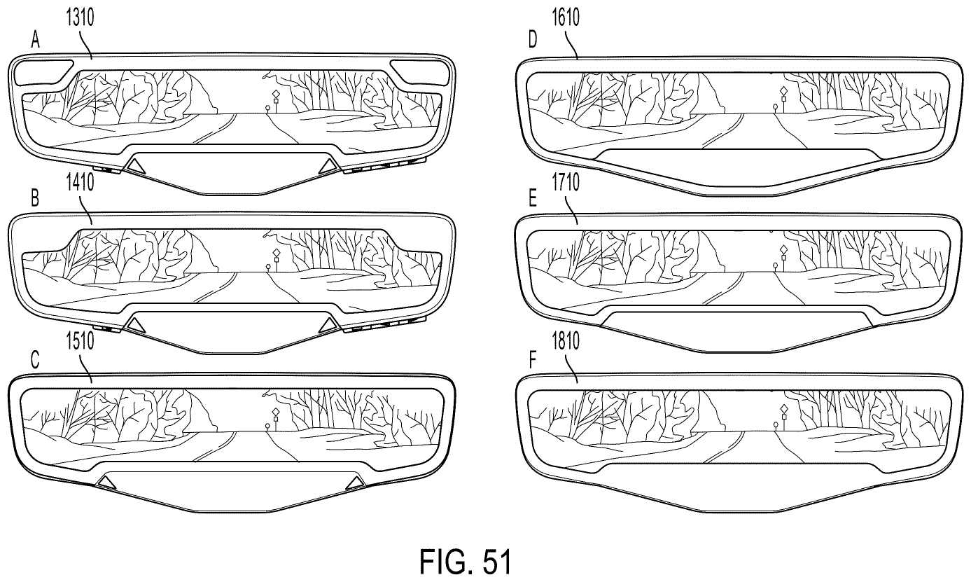

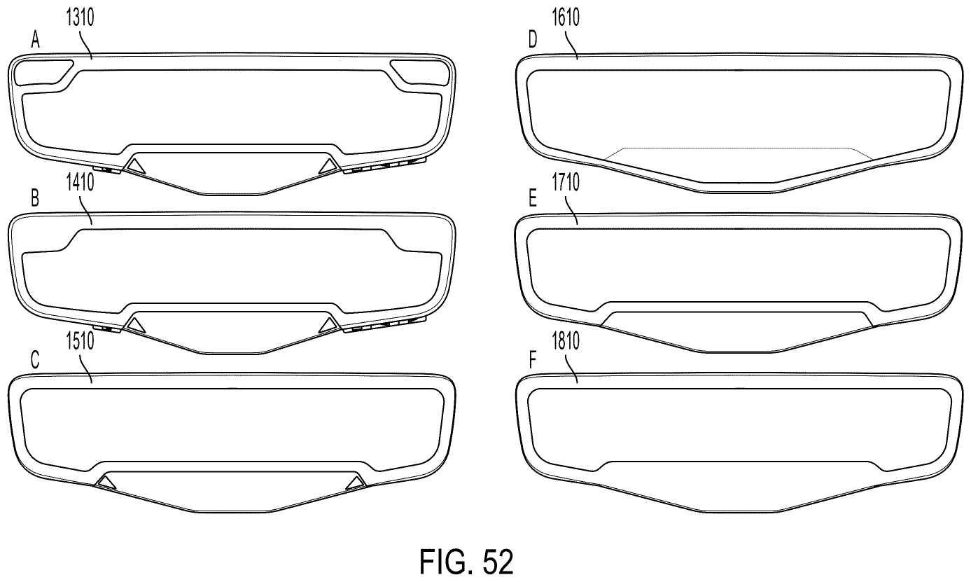

Referring to FIGS. 49 and 50, a mirror assembly 1810 includes a mirror reflective element 1816 having a video display screen 1822 and that extends along a chin portion 1832 of the mirror head 1812. The chin portion 1832 may accommodate a camera and/or one or more light emitters that respectively view and/or emit light through the mirror reflective element 1816. A multi-layer IR transmissive band 1825 is disposed at the mirror reflective element 1816 (such as between the respective glass substrates) and circumscribes the mirror reflective element 1816 and is disposed over and along the chin portion 1812. Thus, the light emitters emit IR or near IR light through the IR transmissive band 1825 and the camera views through the IR transmissive band 1825 and the IR transmissive band 1825 hides or conceals the light emitters and the camera behind the mirror reflective element 1816.

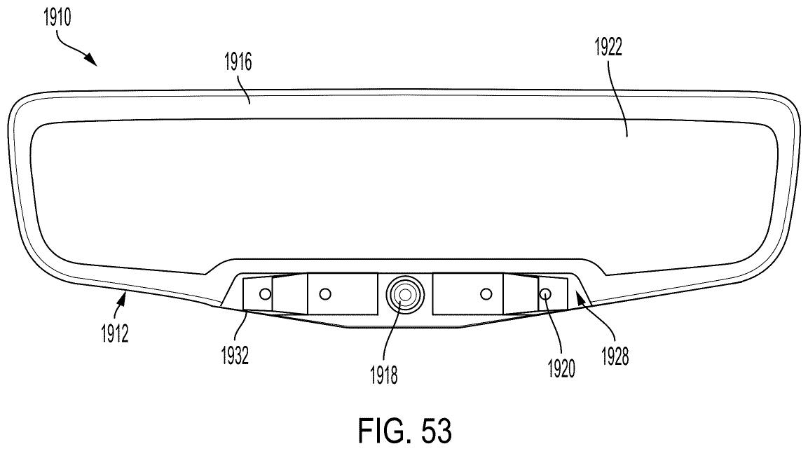

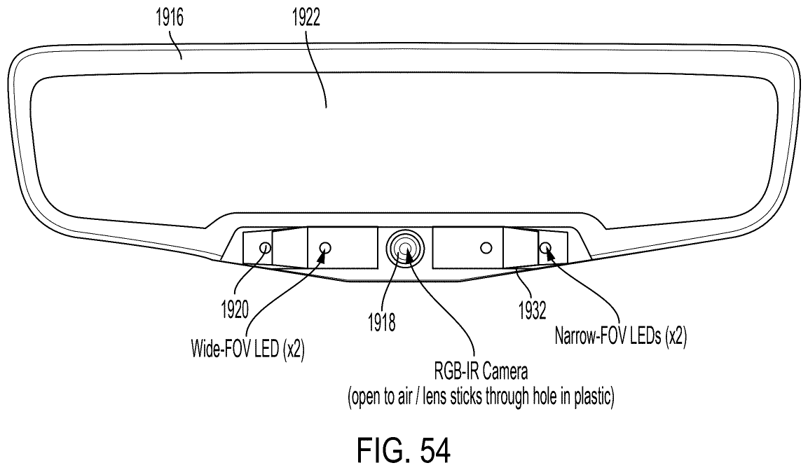

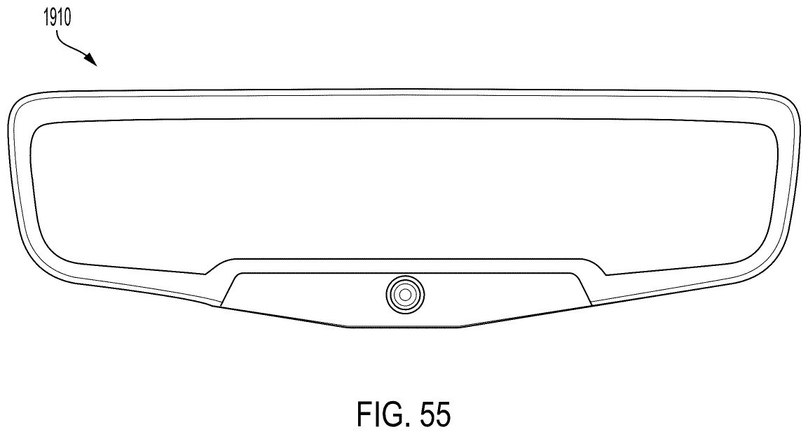

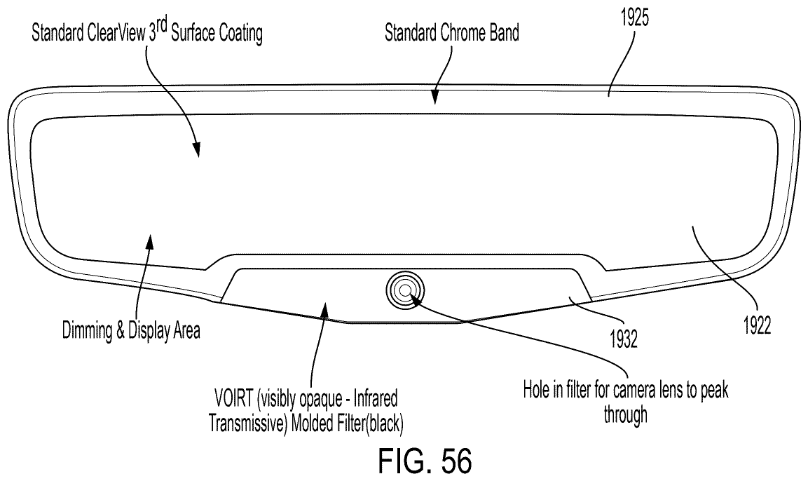

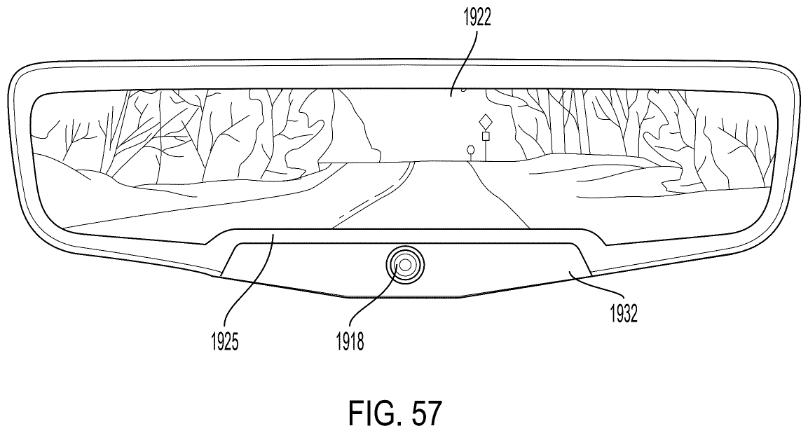

Referring to FIGS. 53-57, an interior rearview mirror assembly 1910 may include a mirror reflective element 1916 that includes a video display screen 1922 and a chin portion 1932 of the mirror head 1912 may extend below the mirror reflective element 1916 and from a cutout region 1928 of the mirror reflective element 1916. The chin portion 1932 may accommodate the camera 1918 and one or more IR light or near IR light emitters 1920. The chin portion 1932 comprises an IR light or near IR light transmissive material that permits transmission of IR light and/or near IR light through the outer surface of the chin portion 1932 and that blocks visible light from transmitting through the outer surface of the chin portion 1932. The camera 1918 extends through the outer surface of the chin portion 1932 (i.e., is exposed at the exterior surface of the mirror head) so that the view of the camera 1918 is not affected by the light transmitting properties of the chin portion cover, and thus the camera 1918 may capture image data representative of visible light and/or IR light reflected from within the vehicle cabin. A light transmissive or non-transmissive band 1925 (such as a chrome band) may be disposed at the mirror reflective element 1916 (such as between the respective glass substrates) and circumscribe the video display screen 1922, such that the band 1925 is between the video display screen 1922 and the chin portion 1932.

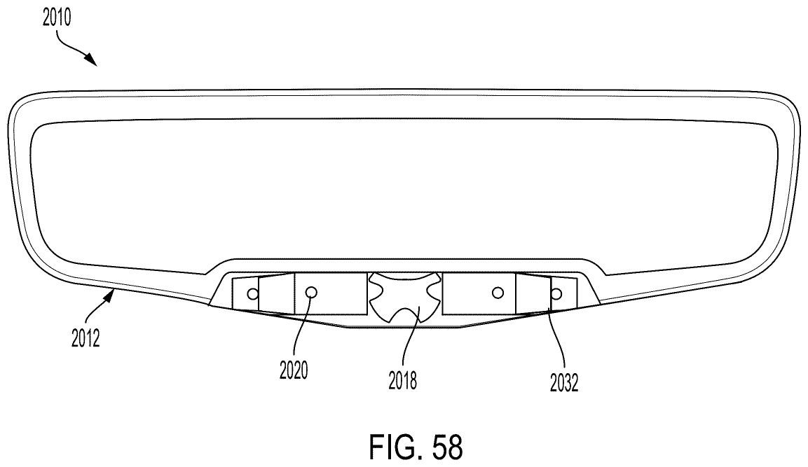

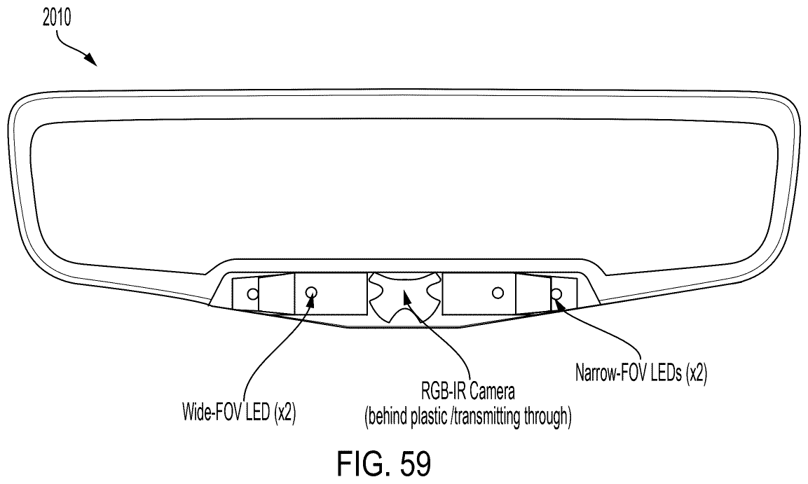

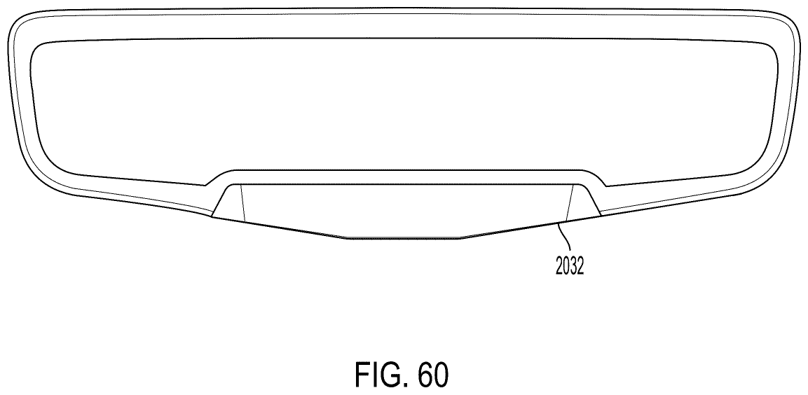

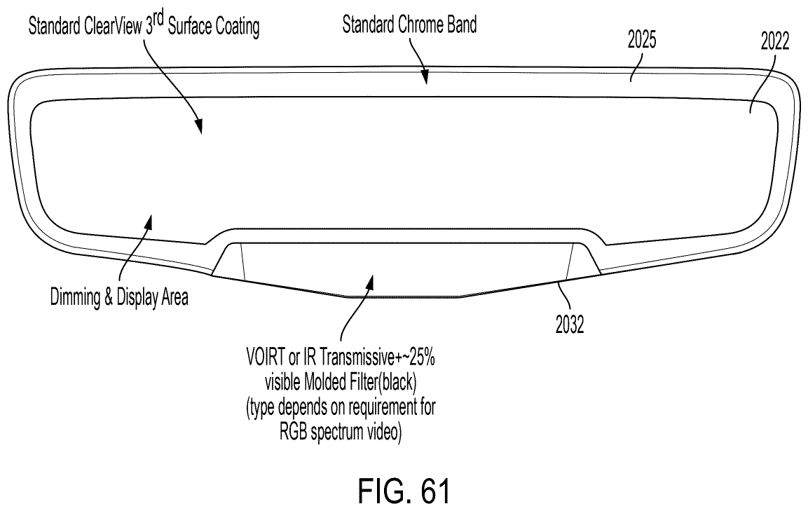

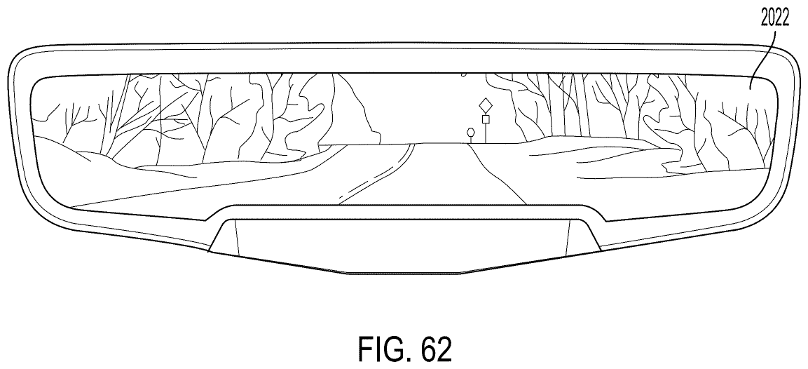

Optionally, and such as shown in FIGS. 58-62 a mirror assembly 2010 may include the camera 2018 disposed behind the plastic cover of the chin portion 2032 of the mirror head 2012 so that the camera views through the chin portion cover. The camera 2018 may capture image data representative of visible light and/or IR light or near IR light from within the vehicle cabin based on the light transmissivity of the chin cover. For example, the chin cover may be configured to allow IR light and/or near IR light to pass through the chin cover and may block a proportion of visible light from passing through the chin cover (such as 25 percent or more, 50 percent or more, 75 percent or more, and the like). Thus, the camera 2018 and/or light emitters 2020 disposed at the chin portion 2032 may be concealed or hidden from view of the driver when viewing the camera assembly. A light transmitting band and/or non-light transmitting band 2025 (such as a chrome band or an IR light transmitting band) may be disposed at the mirror reflective element 2016 (such as between the front glass substrate and the rear glass substrate) and circumscribe the video display screen 2022 of the mirror reflective element.

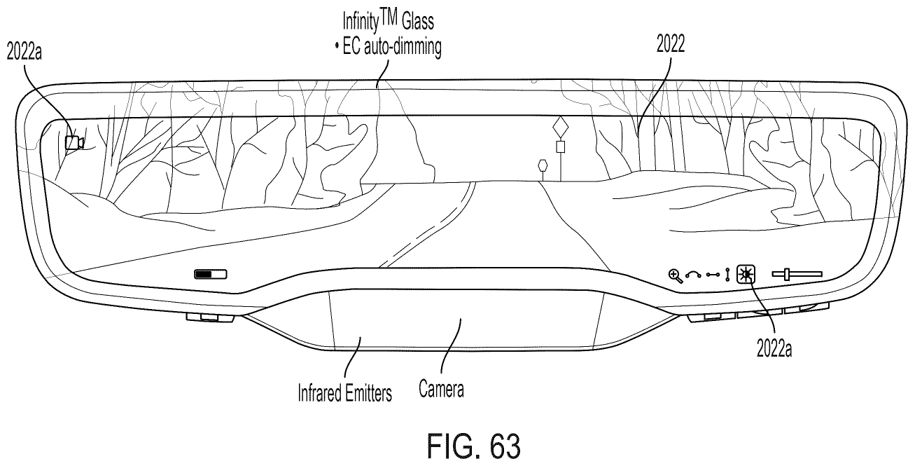

As shown in FIG. 63, the video display screen 2022 may be operable to display one or more icons or overlays 2022a to display information within or over the video images representative of the view rearward of the vehicle. For example, the icons or overlays 2022a may indicate that the images are derived from captured image data (as opposed to the mirror reflective element providing a reflection) or a compass may be overlaid onto the display screen 2022.

Optionally, the camera may be otherwise located at the mirror head and a light pipe or reflector may be used to reflect or guide light from the driver and/or passenger region toward the lens of the camera. The light guide or pipe may comprise a fiber optics light pipe with a light collector that collects light at the mirror reflective element and a light concentrator that directs or concentrates the light at the lens of the camera.

Thus, the DMS camera (and light emitters) are provided at or in a mirror head with a full mirror video display screen. The camera and light emitters are covertly disposed at the mirror head, such as behind the front glass substrate of the mirror reflective element or behind a separate cover panel. The cover or glass substrate has a coating or tint to render covert the camera, while allowing sufficient light to pass through so the camera can capture image data for the driver/occupant monitoring function. The location and angle of the camera are selected to minimize the size of the mirror head while also minimizing effect on the video display screen. The camera may be disposed within the “mirror-shaped” front glass or the camera may be at a chin region to reduce the size of the notch at the lower part of video display.

When the mirror assembly includes a mirror casing that has the chin region, a large vertical height in the chin may be required to account for the video display screen using the full field of view of the exterior viewing camera (e.g., the video display screen is able to display a large enough portion of the field of view of the rear backup camera) and meeting the vertical viewable requirement for the display (e.g., 40 millimeters). Tilting the chin region relative to the mirror reflective element may decrease the vertical dimension of the mirror head and improve the appearance of the mirror assembly while allowing the camera in the mirror assembly to have a field of view suitable to provide the DMS and/or OMS.

For example, the camera may be disposed normal to the mirror reflective element and the cover panel at the chin portion may be tilted or angled relative to the mirror reflective element and camera. A greater angle provides a smaller chin portion and reduced overall mirror height, but may affect the field of view of the camera. In some examples, an angle of the cover portion of the chin relative to the mirror reflective element of 3 degrees may result in a reduction of 2.4 millimeters in the vertical height of the mirror head. An angle of 5 degrees may result in a reduction in height of 3.4 millimeters, and an angle of 7 degrees may result in a reduction in height of 4.1 millimeters.

Optionally, the camera (i.e., the lens and imager) may be disposed normal to the cover panel of the chin portion and thus angled relative to the mirror reflective element. This may allow the bottom of the field of view of the camera to move up and thus decreases the vertical height of the mirror. That is, the cover panel at the chin portion may be shortened to reduce the vertical dimension of the camera's field of view as the lower portions of the field of view may not be needed to provide the DMS and/or OMS. Optionally, the imager may be shifted vertically along the cover panel of the chin portion to reduce the height of the mirror head when the cover panel is tilted and the camera is angled according to the angle of the cover panel. For example, the imager and cover panel of the chin portion may be angled at any suitable angle relative to the mirror reflective element, such as 0 degrees, 10 degrees, 20 degrees, and the like. A mirror head with the cover panel at the chin portion angled relative to the mirror reflective element (such as at 20 degrees) may have a reduction in mirror height of 6.6 millimeters.

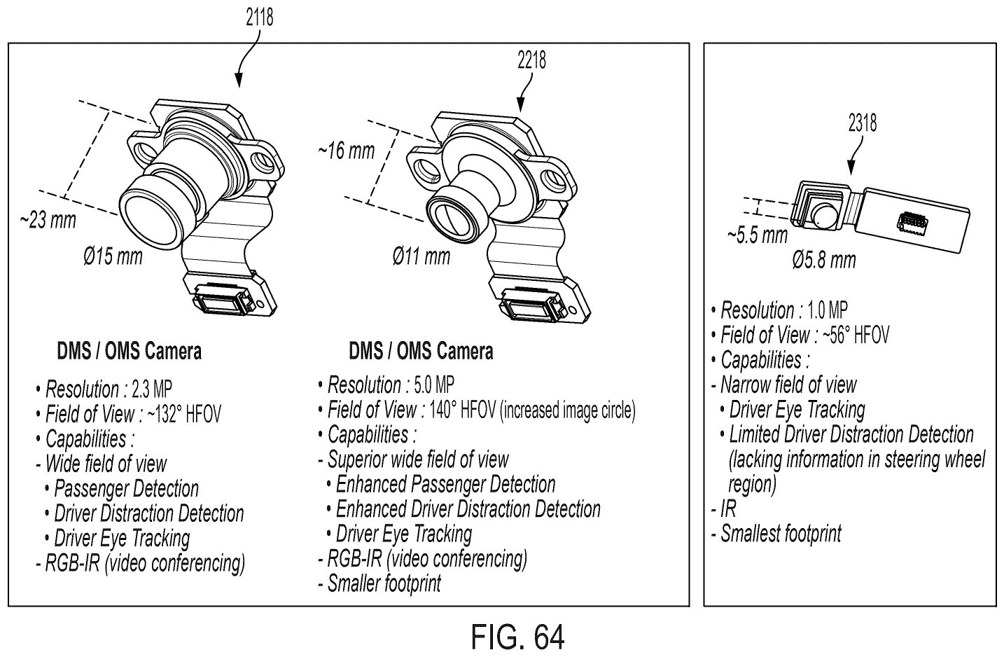

The camera may comprise any suitable camera (see FIG. 64). For example, the DMS/OMS camera may comprise a first camera 2118 having a length (e.g., measured from the imager to the end of the lens) of about 23 millimeters and a diameter of about 15 millimeters. The first camera 2118 may have a resolution of 2.3 megapixels, a field of view of about 132 degrees, and is able to provide a wide field of view for passenger detection, driver distraction detection, driver eye tracking, and captures image data representative of visible light (e.g., RGB for video conferencing) and IR light or near IR light. A second camera 2218 may have a length of about 16 millimeters, a diameter of about 11millimeters, a resolution of 5.0 megapixels, and a field of view of about 140 degrees. The second camera 2218 may provide a superior wide field of view for enhanced passenger detection, enhanced driver distraction detection, driver eye tracking, and captures image data representative of visible light (e.g., RGB for video conferencing) and IR light or near IR light. The second camera 2218 may have a smaller footprint than the first camera 2118.

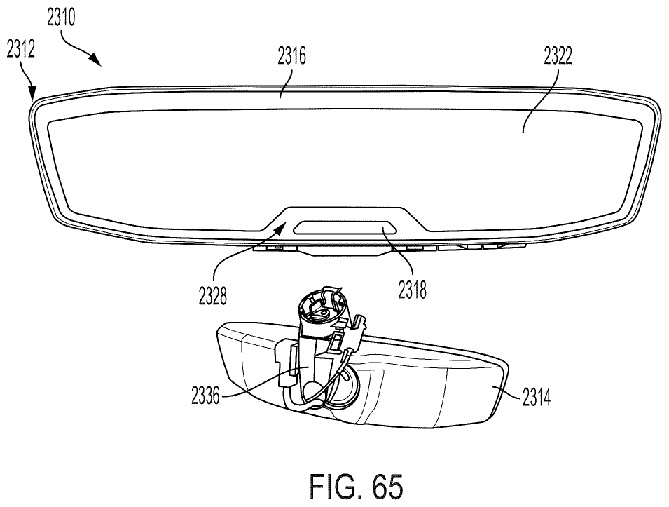

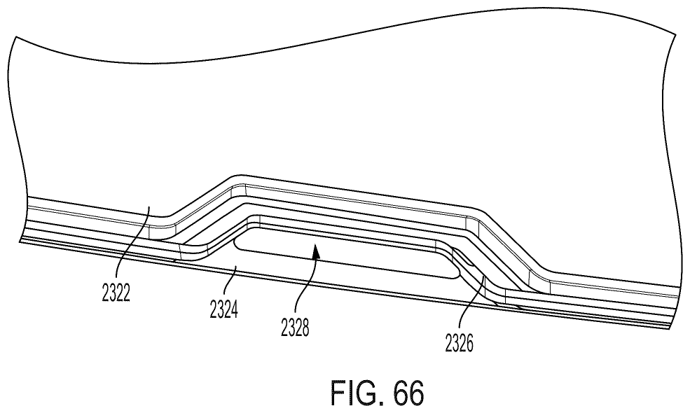

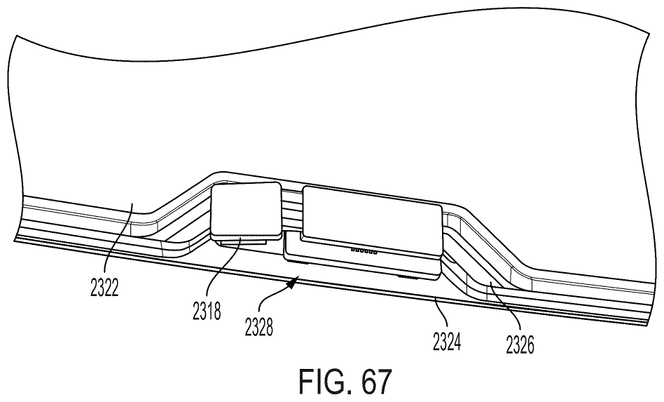

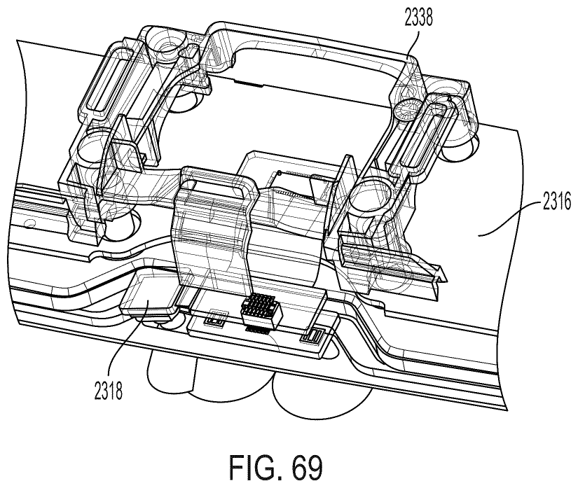

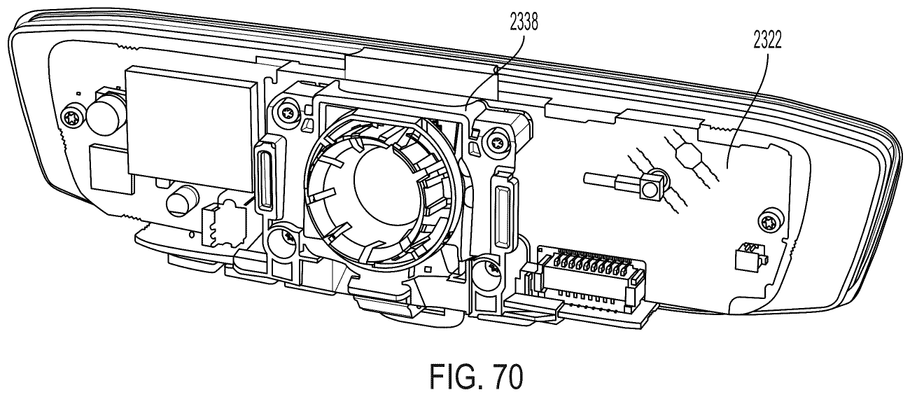

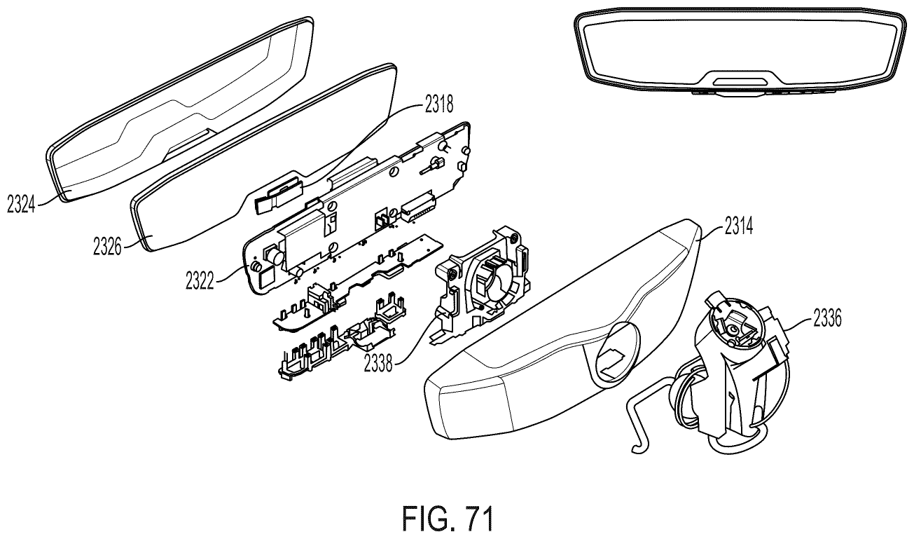

Optionally, the camera may comprise a miniature camera 2318 (FIGS. 65-71). The mini camera may be particularly suitable for a driver monitoring only function (where the system only monitors the driver and does not monitor other occupants of the vehicle). Optionally, two mini cameras may be used (one directed generally toward the left side region of the vehicle and one directed generally toward the right side region of the vehicle) to provide the driver monitoring function and the occupant monitoring function. Image data captured by the two mini cameras may be processed together or separately by the image processor at the ECU of the driver monitoring system. The mini camera(s) provides the smallest footprint and thus has the least effect on the mirror head design and the video display screen. The camera may be angled or canted (such as between 5 degrees and 25 degrees, such as, for example, 15 degrees relative to the plane of the mirror glass) to be generally viewing toward the driver head region when the mirror assembly is installed in a vehicle. In other words, the imager plane of the camera may be angled relative to the mirror reflective element and/or the cover panel so that the view of the camera is biased or canted toward one side of the mirror assembly and the interior cabin of the vehicle. The miniature camera 2318 may have a length of about 5.5 millimeters, a diameter of about 5.8 millimeters, a resolution of 1.0 megapixel, and a field of view of about 56 degrees.

Referring to FIGS. 65-71, a mirror assembly 2310 includes the miniature DMS camera 2318 disposed along a lower edge of the mirror head 2312, such as within a cutout region 2328 along the lower edge of the mirror reflective element 2316. Because of the reduced size of the camera 2318, the mirror head does not need a chin region to accommodate the DMS camera and provide the full video display screen 2322.

Thus, the mirror assembly 2310 includes a mirror head 2312 (that includes a mirror casing 2314 and the mirror reflective element 2316) that mounts at the interior portion of the vehicle via mounting structure 2336 (such as a mounting arm that attaches to the mirror casing via a pivot joint comprising a ball and socket). The mirror reflective element 2316 provides a full screen video display screen 2322 that spans a proportion of the mirror reflective element 2316 (such as 75 percent or more, 85 percent or more, 95 percent or more, and the like). The rear glass substrate 2326 and the video display screen 2322 each comprise respective notches or apertures or cutouts along their lower edge regions to cooperate to form a cutout region 2328 that accommodates the camera 2318. The front glass substrate 2324 of the mirror reflective element 2316 extends over and along the cutout region 2328 and may be dimmable or darkenable to hide or conceal the camera 2318 at the cutout region 2328. Optionally, the front glass substrate 2324 comprises an IR transmissive coating to hide or conceal the camera.

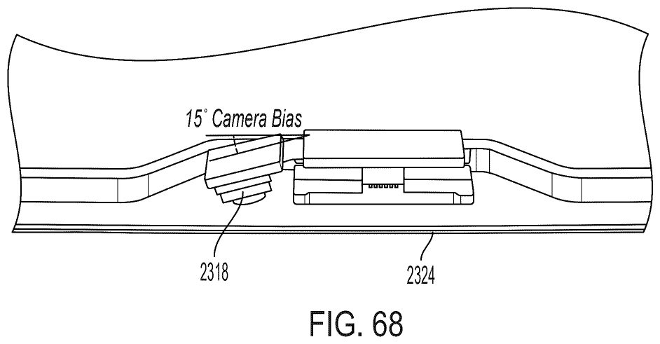

As shown in FIG. 68, the DMS camera 2318 may be disposed at an angle relative to the front glass substrate 2324, such as, for example, a 15 degree angle. For example, the DMS camera 2318 may be angled relative to the front glass substrate 2324 to bias the camera's field of view toward the head region of the driver of the vehicle (e.g., biased or angled toward the left side in FIG. 65 to view the driver side of a left hand drive vehicle). In other words, the principal viewing axis of the camera is biased toward a driver side of the interior portion of the vehicle to capture image data that represents a greater portion of the driver side of the vehicle.

Furthermore, the camera 2318 may be mechanically and/or electrically coupled to the mirror assembly via a frame or carriage 2338 that attaches at the rear of the mirror reflective element 2316 (e.g., a rear surface of a PCB of the video display element). Thus, the camera 2318 may be disposed at the frame 2338 that is coupled to the rear surface of the mirror reflective element 2316 and that extends around and edge of the mirror reflective element 2316 at the cutout region 2328 to position the camera 2318 at the front glass substrate 2324 and within the cutout region 2328. An electrical connector of the camera 2318 may electrically connect to an electrical connector at the frame 2338. The frame 2338 may comprise a socket element that is accessible through the mirror casing 2314 to receive the ball element of the mounting structure 2336.

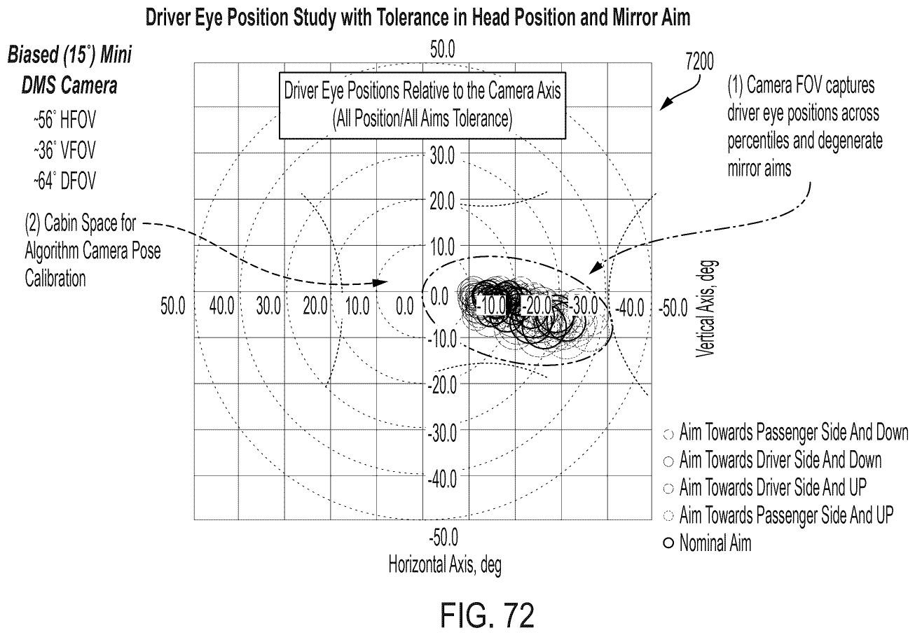

As shown by the diagram 7200 of FIG. 72 the camera 2318 with a smaller field of view and positioned at an angle relative to the mirror reflective element is configured to determine driver eye positions within a camera field of view of 50 degrees or more relative to the principal viewing axis of the camera.

Conventional driver monitoring systems (DMS) in likes of BMW, Ford, GM, Tesla, and Subaru vehicles (for example, for GM SuperCruise™ or for Ford's BlueCruise™ as described in https://www.consumerreports.org/car-safety/driver-monitoring-systems-ford-gm-earn-points-in-cr-tests-a6530426322) are “Two-Box” DMS in that (i) the camera used to monitor the driver's head/eyes and the near-IR emitting light sources that illuminate the driver's head/eyes are accommodated in a first box or module (that is usually located at the steering column of an equipped vehicle or in an overhead region of the equipped vehicle) and (ii) the electronics/software used to analyze captured image data to determine the driver's gaze direction or head position or eye movement or alertness or drowsiness is accommodated in a separate second box or module that is located remote from and at a distance from the first box and that connects to the first box typically via a wired connection (the second box typically comprises an ECU that can be part of a head unit of the equipped vehicle and that besides DMS, optionally can provide other features).

A “One-Box” DMS electrochromic interior rearview mirror assembly has both the camera used to monitor the driver's head/eyes and the near-IR emitting light sources that illuminate the driver's head/eyes accommodated by an interior rearview mirror assembly (and preferably, are both accommodated within the mirror head of the interior rearview mirror assembly). Thus, the one-box DMS electrochromic interior rearview mirror assembly allows an original equipment manufacturer (OEM) of vehicles (such as for example VW or Toyota or Honda or GM or Ford) to equip vehicles with the likes of a DMS interior rearview electrochromic mirror assembly that includes the camera/illumination sources/driver monitoring software/associated driver monitoring electronic circuity such as data processing chip(s), memory, electronic components, printed circuit board(s) that includes automatic dimming circuitry, data processing chip(s), memory, electronic components, light sensors for detecting glare and ambient lighting, and that includes power supplies, electrical connector(s), heat sink(s), mechanical parts, etc. The One-Box Interior DMS Rearview Mirror Assembly thus can be purchased by an OEM from an interior rearview mirror assembly manufacturer and can be installed by that OEM into a being-assembled vehicle (typically mounting to a mirror mounting button or similar element that is adhered to the in-cabin side of the windshield of the vehicle). To operate in the equipped vehicle, the One-Box Interior DMS Rearview Mirror Assembly connects to a vehicle wiring harness of the vehicle and is supplied via this vehicle wiring harness with ignition voltage (nominal 12V DC but can vary from 9V (6V for automatic stop/start) to 16V or so depending on the vehicle type and the operating condition of the vehicle). The one-box Interior DMS rearview mirror assembly via this wiring harness is supplied with vehicle data, such data including vehicle and other data supplied via a CAN bus or link (that can carry to the mirror vehicle information and that can carry from the mirror distraction alerts, etc.) or supplied via a Local Area Network (LIN) bus or line. The wire harness can comprise a reverse inhibit signal/line that communicates to the interior electrochromic mirror assembly that the driver has selected reverse gear/reverse propulsion, an Ethernet link, a video in/out line, electrical power, a ground line, and/or a GMSL/FPD link (video in/out). Video out may be provided, such as for video conferencing and/or “selfies” applications. Optionally, for privacy protection, the images of occupants may be blurred if displayed (during the likes of in-vehicle video conferencing) on an in-cabin display or if wirelessly transmitted to viewers remote from the equipped vehicle. The system may blur the complete image, leaving only the driver/co-driver or all passenger faces clear. Optionally, black bars may be overlaid over the persons' faces. Image stabilization may be provided to compensate potential movements of the image, and/or dynamic cropping of the images may be performed.

The vehicle wire harness also receives outputs/data from the one-box interior rearview mirror assembly DMS, such outputs used for various features, systems and functions of the equipped vehicle. The outputs/data from the one-box interior DMS rearview mirror assembly include data related to head position of a driver of the equipped vehicle, eye gaze direction of the driver of the equipped vehicle, hand position of the driver of the equipped vehicle, drowsiness of the driver of the equipped vehicle, attentiveness of the driver of the equipped vehicle etc., along with other outputs/data relating to some (and preferably all) of the following:
Emotional State
Cognitive Distraction
   Disengagement
   Visual distraction
Level of drowsiness
   Microsleeping
   Sleeping
Visual State
   Gesture
      Head nodding/shaking
   Activity
      Abnormal head posture
      Hand position classification
      Held object classification
      Speaking
      Laughing
      Coughing
      Sneezing
      Yawning
      Smoking
   Phone handling
      Video conferencing
   Viewing target classification
      Child seat detection
      Seat belt status
      Occupant size
      Occupant age
      Gender
      Presence detection
      Convenience recognition
      Security recognition
      Occupant change
      Spoofing
      Facial Expression
Body Pose Tracking
   Eye tracking
   Head tracking
   Eyelid dynamics
   Brightness control
   Face searching
   Mouth Shape
Camera pose estimation
   Frozen image detection
   Face occlusion
   Lens blockage
   Low image quality
   IR light blockage
   Camera misalignment

The interior DMS rearview mirror assembly provides a stand-alone One-Box DMS solution that has the camera/illumination near-IR sources/DMS software and its associated data processing chip(s)/automatic dimming circuitry/circuitry used to control an exterior electrochromic mirror reflective element that is part of an exterior sideview mirror of the equipped vehicle/data processing circuitry/communication circuitry/memory/power supplies/associated electronics and hardware/heat sinks, etc. packaged into, integrated into and accommodated by a vehicular interior rearview mirror assembly, and preferably covertly integrated within the mirror head of the vehicular interior rearview mirror assembly behind (and rendered covert to a driver's view by) a transflective mirror reflective element of the vehicular interior rearview mirror assembly.

The interior rearview mirror thus has embedded cameras, IR illuminators and the processor for processing captured image data for the driver monitoring application. The inward facing camera and IR illuminators are fixed within the mirror head, and thus both components are coupled with the mirror body. Hence, the camera's field of view is subject to change from driver to driver as the mirror head is adjusted to set the driver's preferred rearward view.

The light emitter has two sets of LEDs disposed on the circuit board. One set of LEDs emits a wider beam of near infrared light when energized (e.g., four wider beam LEDs) and another set of LEDs emits a narrower beam of near infrared light when energized (e.g., four narrower beam LEDs). The narrower beam LEDs may be powered or energized for the driver monitoring function, while the wider beam LEDs may be powered or energized for the occupant monitoring function (and may be episodically energized for illuminating particular frames of captured image data, such as by utilizing aspects of the systems described in International Publication Nos. WO 2022/241423 and/or WO 2022/187805, which are hereby incorporated herein by reference in their entireties).

The narrow beam LEDs are angled or canted or biased (e.g., by ten degrees or thereabouts) toward the left and thus toward the driver of a left hand drive vehicle, while the wider beam LEDs are not biased toward either side (e.g., the principal beam axis of light emitted by the wider beam LEDs may be generally perpendicular to the planar outer or front surface of the mirror reflective element). When the mirror assembly is installed in a left hand drive vehicle, the narrow beam LEDs illuminate the driver's head region while the wider beam LEDs illuminate the passenger area as well as the driver area. However, when the mirror assembly is installed in a right hand drive vehicle, the narrow beam LEDs do not illuminate the driver's head region while the wider beam LEDs illuminate the passenger area as well as the driver area.

Having the inward viewing driver monitoring camera in a pivotable rearview mirror head poses unique challenges pertaining to the camera's perspective. In order to account for changes in the camera's view when the mirror head is adjusted, the mirror's driver monitoring processor calculates the camera's location and angle within the vehicle based on the image data captured by the camera and processed by the processor. For example, the system may process image data captured by the driver monitoring camera to determine where particular features are located in the field of view of the camera (such as relative to a particular area of the field of view, such as a central region), and thus the driver monitoring system determines the position of the driver's head by the determined position or positions of particular fixed vehicle features, such as the rear windows, pillars, center console or the like, in the captured image data. The system may adjust processing of the image data captured by the camera to accommodate changes in location of the known or particular vehicle features. For example, if a nominal setting of the mirror has a particular feature a predetermined distance laterally and/or vertically from a center of the image data, if it is determined that the particular feature is shifted or offset to one side or the other from the predetermined distance location, the processor shifts or adjusts processing of captured image data to accommodate the lateral and/or vertical shift of the particular feature. Optionally, the field-of-view of the camera may be biased by offsetting/shifting the lens stack of the camera relative to the imager rather than physically aiming the whole Imager PCB and lens stack. Such shifting of the lens relative to the imager may utilize aspects of the systems described in U.S. Pat. Nos. 10,946,798 and/or 10,525,883, and/or U.S. Pat. Pub. Nos. US-2022-0377219 and/or US-2022-0254132, which are all hereby incorporated herein by reference in their entireties.

The driver monitoring system may provide the ability for the algorithms/camera to determine if the driver has the mirror aimed properly (for providing an acceptable rearward view to the particular driver). Such determination may be made by determining (via processing of image data captured by the camera) the presence and position of (i) the driver's face in a given frame, (ii) adequate light in a given frame relative the driver's head mass, or (iii) the rear window and/or other fixed vehicle features (e.g., D pillars or head rests or the like) in the field of view of the camera. If the system determines that the mirror is aimed improperly, the algorithms may trigger the vehicle to alert the driver of improper use of the interior rearview mirror (such as via an audible alert, or such as via a visual alert, such as an indicator light or display on a display screen, or such as via a haptic alert). Optionally, the mirror may include an actuator that may adjust the mirror head toward a nominal or optimal orientation for the particular driver responsive to determining that the mirror head is aimed improperly for that driver.

The mirror assembly may include a mirror actuator that positions the mirror head at a predetermined or preselected or determined orientation relative to the driver's head. The mirror assembly and/or mirror actuator may utilize aspects of the mirror systems described in U.S. Pat. Nos. 9,616,815; 7,722,199 and/or 6,698,905, which are hereby incorporated herein by reference in their entireties. The mirror assembly (such as the mounting base) may be mounted at the in-cabin side of the vehicle windshield or the mirror assembly may be located or attached elsewhere at the vehicle, such as at an overhead console or headliner of the vehicle or the like.

Optionally, the interior mirror assembly may comprise a dual-mode interior rearview video mirror that can switch from a traditional reflection mode to a live-video display mode, such as is by utilizing aspects of the mirror assemblies and systems described in U.S. Pat. Nos. 10,442,360; 10,421,404; 10,166,924 and/or 10,046,706, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The electrically operated actuator may provide the memory setting function and may also operate to adjust the mirror head between the reflection mode and video display mode, such as responsive to a user actuatable input in the vehicle or at the mirror assembly (e.g., a toggle or switch or button at the mirror head).

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application.

The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are hereby incorporated herein by reference in their entireties. The connections between the cameras and the controller or PCB(s) and/or between the displays and the controllers or PCBs may be made via respective coaxial cables, which may provide power and control of the cameras (by the controller) and which may provide image data from the cameras to the controller, and which may provide video images from the controller to the display devices. The connections and communications may utilize aspects of the systems described in U.S. Pat. Nos. 10,264,219; 9,900,490 and/or 9,609,757, which are hereby incorporated herein by reference in their entireties.

The mirror reflective element may comprise a variable reflectance electro-optic mirror reflective element, such as an electrochromic mirror reflective element or a liquid crystal mirror reflective element. For example, the mirror reflective element may comprise a laminate construction variable reflectance electro-optic (such as electrochromic) reflective element assembly having a front glass substrate and a rear glass substrate with an electro-optic medium (such as electrochromic medium) sandwiched therebetween and bounded by a perimeter seal. The front substrate has a front or first surface (the surface that generally faces the driver of a vehicle when the mirror assembly is normally mounted at the vehicle) and a rear or second surface opposite the front surface, and the rear substrate has a front or third surface and a rear or fourth surface opposite the front surface, with the electro-optic medium disposed between the second surface and the third surface and bounded by the perimeter seal of the reflective element (such as is known in the electrochromic mirror art). The second surface has a transparent conductive coating established thereat (such as an indium tin oxide (ITO) layer, or a doped tin oxide layer or any other transparent electrically semi-conductive layer or coating or the like, such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface has a metallic reflector coating (or multiple layers or coatings) established thereat. The front or third surface of the rear substrate may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties.

The mirror reflector may comprise any suitable coatings or layers, such as a transflective coating or layer (that is partially transmissive of visible light and/or near infrared light and that is partially reflective of visible light), such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal. Optionally, the mirror reflector could be disposed at the rear surface of the rear substrate (commonly referred to as the fourth surface of the reflective element). The driver monitoring camera may be accommodated in the mirror head and view through the transflective mirror reflector toward the driver's head region and/or the near IR light emitter may be accommodated in the mirror head and emit light that passes through the transflective mirror reflector to illuminate the driver's head region. The transflective mirror reflector may be spectrally tuned so as to transmit or pass a particular spectral band of light (e.g., near infrared light) while reflecting other spectral bands of light (e.g., visible light). The camera may be sensitive to near infrared light, such that the near IR light emitter can emit near IR light that passes through the transflective mirror reflector and the camera may be sensitive to the near IR light that reflects off of the driver's head and passes back through the transflective mirror reflector. Thus, the transflective mirror reflector of the mirror reflective element may transmit near IR light incident thereon, transmit at least a portion of visible light incident thereon, and reflect at least a portion of visible light incident thereon.

The third surface defines the active EC area or surface of the rear substrate within the perimeter seal. The coated third surface may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

The reflective element and mirror casing are adjustable relative to a base portion or mounting base or mounting structure or mounting assembly to adjust the driver's rearward ‘view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5, 100,095; 7,249,860; 6,877,709; 6,329,925; 7,289,037; 7,249,860 and/or 6,483,438, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and without overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 8,508,831; 8,730,553; 9,598,016 and/or 9,346,403, and/or U.S. Publication Nos. US-2014-0313563 and/or US-2015-0097955, which are hereby incorporated herein by reference in their entireties (and with electrochromic and prismatic mirrors of such construction are commercially available from the assignee of this application under the trade name INFINITY™ mirror). Optionally, the mirror reflective element may comprise a variable reflectivity liquid crystal (VRLC) reflective element, such as by utilizing aspects of the mirror assemblies described in U.S. Publication No. US-2022-371513, which is hereby incorporated herein by reference in its entirety.

Optionally, the mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 8,508,831 and/or 8,730,553, and/or U.S. Publication Nos. US-2014-0022390; US-2014-0293169 and/or US-2015-0097955, which are hereby incorporated herein by reference in their entireties).

Although shown as an electro-optic mirror application, it is envisioned that the mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 7,420,756; 7,338,177; 7,289,037; 7,274,501; 7,255,451; 7,249,860; 6,318,870; 6,598,980; 5,327,288; 4,948,242; 4,826,289; 4,436,371 and/or 4,435,042, and/or U.S. Publication No. US-2010-0085653, which are hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855;755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736 and/or US-2010-0097469, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,690,268; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606; 7,720,580; 8,446,470; 8,451,107 and/or 9,126,525, and/or U.S. Pat. Pub. Nos. US-2006-0171704; US-2009-0244361 and/or US-2010-0214791, which are all hereby incorporated herein by reference in their entireties. The imaging sensor or camera may be activated and the display screen may be activated in response to the vehicle shifting into reverse, such that the display screen is viewable by the driver and is displaying an image of the rearward scene while the driver is reversing the vehicle. It is envisioned that the image processor or controller may comprise the likes of an EYEQ™ image processing chip available from Mobileye Vision Technologies Ltd. of Jerusalem, Israel, and processes image data captured by the forward viewing camera and the driver monitoring camera (and optionally surround view cameras and/or CMS cameras of the vehicle).

An aspect of the present disclosure includes a vehicular driver monitoring system. The vehicular driver monitoring system includes a vehicular interior rearview mirror assembly that includes a mirror head adjustably attached at a mounting base. The mounting base is configured to attach at an interior portion of a vehicle equipped with the vehicular driver monitoring system. The mirror head accommodates a mirror reflective element. The mirror reflective element includes a transflective mirror reflector. The transflective mirror reflector of the mirror reflective element transmits near infrared light incident thereon, transmits visible light incident thereon and reflects visible light incident thereon. The mirror reflective element comprises a reflective region defined by the transflective mirror reflector. A video display device is disposed rearward of the mirror reflective element. The video display device includes a video display screen that occupies at least 75 percent of the reflective region of the mirror reflective element. The video display device is operable to display video images captured by a rearward viewing camera of the vehicle. With the mounting base attached at the interior portion of the vehicle, and when the video display device is operated to display video images captured by the rearward viewing camera, visible light emitted by the video display device passes through the transflective mirror reflector of the mirror reflective element for viewing of displayed video images by a driver of the vehicle viewing the mirror reflective element. A driver monitoring camera is accommodated by the mirror head. The driver monitoring camera moves together and in tandem with the mirror head when, with the mounting base attached at the interior portion of the vehicle, the mirror head is adjusted relative to the mounting base to set a rearward view of the driver of the vehicle. A near infrared light emitter is accommodated by the mirror head. The near infrared light emitter moves together and in tandem with the mirror head when, with the mounting base attached at the interior portion of the vehicle, the mirror head is adjusted relative to the mounting base to set the rearward view of the driver of the vehicle. The near infrared light emitter is accommodated by the mirror head so that, with the mounting base attached at the interior portion of the vehicle and with the mirror head adjusted relative to the mounting base to set the rearward view of the driver of the vehicle, a beam of near infrared light emitted by the near infrared light emitter is directed toward a driver's region of the vehicle. The driver monitoring camera is disposed adjacent to the video display screen so as to not view through the video display screen.

In some implementations, the mirror head includes electronic circuitry. The electronic circuitry includes a processor operable to process image data captured by the driver monitoring camera. With the mounting base attached at the interior portion of the vehicle, the processor processes image data captured by the driver monitoring camera to determine at least one selected from the group consisting of (i) driver attentiveness, (ii) driver drowsiness and (iii) driver gaze direction.

In some examples, the video display screen occupies at least 85 percent of the reflective region of the mirror reflective element. In some examples, the video display screen occupies at least 95 percent of the reflective region of the mirror reflective element.

Optionally, the driver monitoring camera views through a portion of the transflective mirror reflector of the mirror reflective element that is not disposed in front of the video display screen.

In some implementations, the driver monitoring camera does not view through the transflective mirror reflector of the mirror reflective element. In further implementations, the driver monitoring camera is disposed behind a cover panel that is coated to render covert the driver monitoring camera to a person viewing the mirror reflective element when the interior rearview mirror assembly is installed in the vehicle. In even further implementations, the cover panel is accommodated by the mirror head and is disposed adjacent a lower edge of the mirror reflective element. Optionally, an outer surface of the cover panel is coplanar with an outer surface of the mirror reflective element at the lower edge of the mirror reflective element.

Optionally, an outer surface of the cover panel is disposed at an oblique angle relative to an outer surface of the mirror reflective element at the lower edge of the mirror reflective element. For example, the cover panel may be disposed at an angle relative to the outer surface of the mirror reflective element at the lower edge of the mirror reflective element of one degree or less, two degrees or less, three degrees or less, four degrees or less, five degrees or less, six degrees or less, seven degrees or less, ten degrees or less, twenty degrees or less and the like.

Optionally, an imager plane of the driver monitoring camera is parallel to an outer surface of the cover panel. The imager plane and the outer surface of the cover panel may be disposed at an oblique angle relative to an outer surface of the mirror reflective element at the lower edge of the mirror reflective element. For example, the imager plane and the outer surface of the cover panel are disposed at an angle relative to the outer surface of the mirror reflective element at the lower edge of the mirror reflective element of one degree or less, five degrees or less, ten degrees or less, twenty degrees or less, and the like.

Optionally, an imager plane of the driver monitoring camera is disposed at an oblique angle relative to an inner surface of the cover panel. For example, the imager plane of the driver monitoring camera is disposed at an angle relative to the inner surface of the cover panel of one degree or less, five degrees or less, ten degrees or less, fifteen degrees or less, twenty degrees or less, twenty-five degrees or less, and the like.

The cover panel may be coated with a near infrared light transmissive coating. The infrared light transmissive coating at least partially allows transmission of near infrared light and at least partially blocks transmission of visible light.

In some implementations, the mirror reflective element includes an electrochromic mirror reflective element having a front glass substrate and a rear glass substrate with an electrochromic medium sandwiched therebetween. In further implementations, the driver monitoring camera is disposed behind and views through an overhang region of the front glass substrate that extends beyond the rear glass substrate, and the driver monitoring camera does not view through the rear glass substrate. In even further implementations, the overhang region of the front glass substrate is coated with a near infrared light transmissive coating that at least partially allows transmission of near infrared light and that at least partially blocks transmission of visible light. The near infrared light transmissive coating is configured to block transmission of visible light incident at the near infrared light transmissive coating, such as 75 percent of visible light incident thereat, 85 percent of visible light incident thereat, 95 percent of visible light incident thereat, and the like.

In some further implementations, the driver monitoring camera is disposed at least partially within a cutout region along a lower edge of the rear glass substrate. In some even further implementations, the near infrared light emitter is disposed at least partially within the cutout region.

In other further implementations, the rear glass substrate includes one or more cutout regions along a peripheral edge region of the rear glass substrate. The front glass substrate extends at least partially over and along the one or more cutout regions. In other even further implementations, the one or more cutout regions include (i) a first cutout region along a lower portion of the peripheral edge region of the rear glass substrate, (ii) a second cutout region along a first side portion of the peripheral edge region of the rear glass substrate and (iii) a third cutout region along a second side portion of the peripheral edge region of the rear glass substrate. The second side portion is opposite the first side portion. The driver monitoring camera may be accommodated within the mirror head at the first cutout region, a first near infrared light emitter may be accommodated within the mirror head at the second cutout region and a second near infrared light emitter may be accommodated within the mirror head at the third cutout region. Optionally, the second cutout region and the third cutout region are disposed along an upper portion of the peripheral edge region of the rear glass substrate that is opposite the lower portion. Optionally, the second cutout region and the third cutout region extend between the lower portion of the peripheral edge region of the rear glass substrate and an upper portion of the peripheral edge region of the rear glass substrate that is opposite the lower portion.

In some examples, with the mounting base attached at the interior portion of the vehicle, the vehicular interior rearview mirror assembly is operable in a mirror mode and is operable in a display mode. In further examples, with the mounting base attached at the interior portion of the vehicle, and with the vehicular interior rearview mirror assembly operating in the mirror mode, the driver of the vehicle views reflections at the mirror reflective element to view rearward of the vehicle. With the mounting base attached at the interior portion of the vehicle, and with the vehicular interior rearview mirror assembly operating in the display mode, the video display screen is operated to display video images for viewing by the driver through the mirror reflective element.

In some implementations, the mirror head includes a chin portion extending from a lower edge region of the mirror head. The driver monitoring camera is at least partially accommodated by the chin portion of the mirror head. In further implementations, the mirror reflective element extends over and along the driver monitoring camera at the chin portion of the mirror head so that the driver monitoring camera views through the mirror reflective element. In other further implementations, a cover panel extends from a lower edge region of the mirror reflective element and over and along the driver monitoring camera at the chin portion of the mirror head so that the driver monitoring camera views through the cover panel.

Optionally, a principal viewing axis of the driver monitoring camera is biased toward a driver side of the interior portion of the vehicle.

Changes and modifications in the specifically described embodiments may be carried out without departing from the principles of the present invention, which is intended to be limited only by the scope of the appended claims as interpreted according to the principles of patent law.

1. A vehicular driver monitoring system, the vehicular driver monitoring system comprising:
a vehicular interior rearview mirror assembly comprising a mirror head adjustably attached at a mounting base, the mounting base configured to attach at an interior portion of a vehicle equipped with the vehicular driver monitoring system;
wherein the mirror head accommodates a mirror reflective element;
wherein the mirror reflective element comprises a transflective mirror reflector, and wherein the transflective mirror reflector of the mirror reflective element transmits near infrared light incident thereon, transmits visible light incident thereon and reflects visible light incident thereon;
wherein the mirror reflective element comprises a reflective region defined by the transflective mirror reflector;
a video display device disposed rearward of the mirror reflective element;
wherein the video display device comprises a video display screen that occupies at least 75 percent of the reflective region of the mirror reflective element;
wherein the video display device is operable to display video images captured by a rearward viewing camera of the vehicle;
wherein, with the mounting base attached at the interior portion of the vehicle, and when the video display device is operated to display video images captured by the rearward viewing camera, visible light emitted by the video display device passes through the transflective mirror reflector of the mirror reflective element for viewing of displayed video images by a driver of the vehicle viewing the mirror reflective element;
a driver monitoring camera accommodated by the mirror head, wherein the driver monitoring camera moves together and in tandem with the mirror head when, with the mounting base attached at the interior portion of the vehicle, the mirror head is adjusted relative to the mounting base to set a rearward view of the driver of the vehicle;
a near infrared light emitter accommodated by the mirror head, wherein the near infrared light emitter moves together and in tandem with the mirror head when, with the mounting base attached at the interior portion of the vehicle, the mirror head is adjusted relative to the mounting base to set the rearward view of the driver of the vehicle;
wherein the near infrared light emitter is accommodated by the mirror head so that, with the mounting base attached at the interior portion of the vehicle and with the mirror head adjusted relative to the mounting base to set the rearward view of the driver of the vehicle, a beam of near infrared light emitted by the near infrared light emitter is directed toward a driver's region of the vehicle; and
wherein the driver monitoring camera is disposed adjacent to the video display screen so as to not view through the video display screen.

2. The vehicular driver monitoring system of claim 1, wherein the mirror head includes electronic circuitry, and wherein the electronic circuitry comprises a processor operable to process image data captured by the driver monitoring camera, and wherein, with the mounting base attached at the interior portion of the vehicle, the processor processes image data captured by the driver monitoring camera to determine at least one selected from the group consisting of (i) driver attentiveness, (ii) driver drowsiness and (iii) driver gaze direction.

3. The vehicular driver monitoring system of claim 1, wherein the video display screen occupies at least 85 percent of the reflective region of the mirror reflective element.

4. The vehicular driver monitoring system of claim 1, wherein the video display screen occupies at least 95 percent of the reflective region of the mirror reflective element.

5. The vehicular driver monitoring system of claim 1, wherein the driver monitoring camera views through a portion of the transflective mirror reflector of the mirror reflective element that is not disposed in front of the video display screen.

6. The vehicular driver monitoring system of claim 1, wherein the driver monitoring camera does not view through the transflective mirror reflector of the mirror reflective element.

7. The vehicular driver monitoring system of claim 6, wherein the driver monitoring camera is disposed behind a cover panel that is coated to render covert the driver monitoring camera to a person viewing the mirror reflective element when the vehicular interior rearview mirror assembly is installed in the vehicle.

8. The vehicular driver monitoring system of claim 7, wherein the cover panel is accommodated by the mirror head and is disposed adjacent a lower edge of the mirror reflective element.

9. The vehicular driver monitoring system of claim 8, wherein an outer surface of the cover panel is coplanar with an outer surface of the mirror reflective element at the lower edge of the mirror reflective element.

10. The vehicular driver monitoring system of claim 8, wherein an outer surface of the cover panel is disposed at an oblique angle relative to an outer surface of the mirror reflective element at the lower edge of the mirror reflective element.

11. The vehicular driver monitoring system of claim 10, wherein the cover panel is disposed at an angle of one degree or less relative to the outer surface of the mirror reflective element at the lower edge of the mirror reflective element.

12. The vehicular driver monitoring system of claim 10, wherein the cover panel is disposed at an angle of two degrees or less relative to the outer surface of the mirror reflective element at the lower edge of the mirror reflective element.

13. The vehicular driver monitoring system of claim 10, wherein the cover panel is disposed at an angle of three degrees or less relative to the outer surface of the mirror reflective element at the lower edge of the mirror reflective element.

14. The vehicular driver monitoring system of claim 10, wherein the cover panel is disposed at an angle of four degrees or less relative to the outer surface of the mirror reflective element at the lower edge of the mirror reflective element.

15. The vehicular driver monitoring system of claim 10, wherein the cover panel is disposed at an angle of five degrees or less relative to the outer surface of the mirror reflective element at the lower edge of the mirror reflective element.

16. The vehicular driver monitoring system of claim 10, wherein the cover panel is disposed at an angle of six degrees or less relative to the outer surface of the mirror reflective element at the lower edge of the mirror reflective element.

17. The vehicular driver monitoring system of claim 10, wherein the cover panel is disposed at an angle of seven degrees or less relative to the outer surface of the mirror reflective element at the lower edge of the mirror reflective element.

18. The vehicular driver monitoring system of claim 10, wherein the cover panel is disposed at an angle of ten degrees or less relative to the outer surface of the mirror reflective element at the lower edge of the mirror reflective element.

19. The vehicular driver monitoring system of claim 10, wherein the cover panel is disposed at an angle of twenty degrees or less relative to the outer surface of the mirror reflective element at the lower edge of the mirror reflective element.

20. The vehicular driver monitoring system of claim 8, wherein an imager plane of the driver monitoring camera is parallel to an outer surface of the cover panel.

21. The vehicular driver monitoring system of claim 20, wherein the imager plane and the outer surface of the cover panel are disposed at an oblique angle relative to an outer surface of the mirror reflective element at the lower edge of the mirror reflective element.

22. The vehicular driver monitoring system of claim 21, wherein the imager plane and the outer surface of the cover panel are disposed at an angle of one degree or less relative to the outer surface of the mirror reflective element at the lower edge of the mirror reflective element.

23. The vehicular driver monitoring system of claim 21, wherein the imager plane and the outer surface of the cover panel are disposed at an angle of five degrees or less relative to the outer surface of the mirror reflective element at the lower edge of the mirror reflective element.

24. The vehicular driver monitoring system of claim 21, wherein the imager plane and the outer surface of the cover panel are disposed at an angle of ten degrees or less relative to the outer surface of the mirror reflective element at the lower edge of the mirror reflective element.

25. The vehicular driver monitoring system of claim 21, wherein the imager plane and the outer surface of the cover panel are disposed at an angle of twenty degrees or less relative to the outer surface of the mirror reflective element at the lower edge of the mirror reflective element.

26. The vehicular driver monitoring system of claim 8, wherein an imager plane of the driver monitoring camera is disposed at an oblique angle relative to an inner surface of the cover panel.

27. The vehicular driver monitoring system of claim 26, wherein the imager plane of the driver monitoring camera is disposed at an angle of one degree or less relative to the inner surface of the cover panel.

28. The vehicular driver monitoring system of claim 26, wherein the imager plane of the driver monitoring camera is disposed at an angle of five degrees or less relative to the inner surface of the cover panel.

29. The vehicular driver monitoring system of claim 26, wherein the imager plane of the driver monitoring camera is disposed at an angle of ten degrees or less relative to the inner surface of the cover panel.

30. The vehicular driver monitoring system of claim 26, wherein the imager plane of the driver monitoring camera is disposed at an angle of fifteen degrees or less relative to the inner surface of the cover panel.

31. The vehicular driver monitoring system of claim 26, wherein the imager plane of the driver monitoring camera is disposed at an angle of twenty degrees or less relative to the inner surface of the cover panel.

32. The vehicular driver monitoring system of claim 26, wherein the imager plane of the driver monitoring camera is disposed at an angle of twenty-five degrees or less relative to the inner surface of the cover panel.

33. The vehicular driver monitoring system of claim 7, wherein the cover panel is coated with a near infrared light transmissive coating that at least partially allows transmission of near infrared light and that at least partially blocks transmission of visible light.

34. The vehicular driver monitoring system of claim 1, wherein the mirror reflective element comprises an electrochromic mirror reflective element having a front glass substrate and a rear glass substrate with an electrochromic medium sandwiched therebetween.

35. The vehicular driver monitoring system of claim 34, wherein the driver monitoring camera is disposed behind and views through an overhang region of the front glass substrate that extends beyond the rear glass substrate, and wherein the driver monitoring camera does not view through the rear glass substrate.

36. The vehicular driver monitoring system of claim 35, wherein the overhang region of the front glass substrate is coated with a near infrared light transmissive coating that at least partially allows transmission of near infrared light and that at least partially blocks transmission of visible light.

37. The vehicular driver monitoring system of claim 36, wherein the near infrared light transmissive coating is configured to block transmission of at least 75 percent of visible light incident at the near infrared light transmissive coating.

38. The vehicular driver monitoring system of claim 36, wherein the near infrared light transmissive coating is configured to block transmission of at least 85 percent of visible light incident at the near infrared light transmissive coating.

39. The vehicular driver monitoring system of claim 36, wherein the near infrared light transmissive coating is configured to block transmission of at least 95 percent of visible light incident at the near infrared light transmissive coating.

40. The vehicular driver monitoring system of claim 34, wherein the driver monitoring camera is disposed at least partially within a cutout region along a lower edge of the rear glass substrate.

41. The vehicular driver monitoring system of claim 40, wherein the near infrared light emitter is disposed at least partially within the cutout region.

42. The vehicular driver monitoring system of claim 34, wherein the rear glass substrate comprises one or more cutout regions along a peripheral edge region of the rear glass substrate, and wherein the front glass substrate extends at least partially over and along the one or more cutout regions.

43. The vehicular driver monitoring system of claim 42, wherein the one or more cutout regions comprise (i) a first cutout region along a lower portion of the peripheral edge region of the rear glass substrate, (ii) a second cutout region along a first side portion of the peripheral edge region of the rear glass substrate and (iii) a third cutout region along a second side portion of the peripheral edge region of the rear glass substrate, wherein the second side portion is opposite the first side portion.

44. The vehicular driver monitoring system of claim 43, wherein the driver monitoring camera is accommodated within the mirror head at the first cutout region, a first near infrared light emitter is accommodated within the mirror head at the second cutout region and a second near infrared light emitter is accommodated within the mirror head at the third cutout region.

45. The vehicular driver monitoring system of claim 43, wherein the second cutout region and the third cutout region are disposed along an upper portion of the peripheral edge region of the rear glass substrate that is opposite the lower portion.

46. The vehicular driver monitoring system of claim 43, wherein the second cutout region and the third cutout region extend between the lower portion of the peripheral edge region of the rear glass substrate and an upper portion of the peripheral edge region of the rear glass substrate that is opposite the lower portion.

47. The vehicular driver monitoring system of claim 1, wherein, with the mounting base attached at the interior portion of the vehicle, the vehicular interior rearview mirror assembly is operable in a mirror mode and is operable in a display mode.

48. The vehicular driver monitoring system of claim 47, wherein, with the mounting base attached at the interior portion of the vehicle, and with the vehicular interior rearview mirror assembly operating in the mirror mode, the driver of the vehicle views reflections at the mirror reflective element to view rearward of the vehicle, and wherein, with the mounting base attached at the interior portion of the vehicle, and with the vehicular interior rearview mirror assembly operating in the display mode, the video display screen is operated to display video images for viewing by the driver through the mirror reflective element.

49. The vehicular driver monitoring system of claim 1, wherein the mirror head comprises a chin portion extending from a lower edge region of the mirror head, and wherein the driver monitoring camera is at least partially accommodated by the chin portion of the mirror head.

50. The vehicular driver monitoring system of claim 49, wherein the mirror reflective element extends over and along the driver monitoring camera at the chin portion of the mirror head so that the driver monitoring camera views through the mirror reflective element.

51. The vehicular driver monitoring system of claim 49, wherein a cover panel extends from a lower edge region of the mirror reflective element and over and along the driver monitoring camera at the chin portion of the mirror head so that the driver monitoring camera views through the cover panel.

52. The vehicular driver monitoring system of claim 1, wherein a principal viewing axis of the driver monitoring camera is biased toward a driver side of the interior portion of the vehicle.

53. A vehicular driver monitoring system, the vehicular driver monitoring system comprising:
a vehicular interior rearview mirror assembly comprising a mirror head adjustably attached at a mounting base, the mounting base configured to attach at an interior portion of a vehicle equipped with the vehicular driver monitoring system;
wherein the mirror head accommodates a mirror reflective element;
wherein the mirror reflective element comprises a transflective mirror reflector, and wherein the transflective mirror reflector of the mirror reflective element transmits near infrared light incident thereon, transmits visible light incident thereon and reflects visible light incident thereon;
wherein the mirror reflective element comprises a reflective region defined by the transflective mirror reflector;
a video display device disposed rearward of the mirror reflective element;
wherein the video display device comprises a video display screen that occupies at least 75 percent of the reflective region of the mirror reflective element;
wherein the video display device is operable to display video images captured by a rearward viewing camera of the vehicle;
wherein, with the mounting base attached at the interior portion of the vehicle, and when the video display device is operated to display video images captured by the rearward viewing camera, visible light emitted by the video display device passes through the transflective mirror reflector of the mirror reflective element for viewing of displayed video images by a driver of the vehicle viewing the mirror reflective element;
wherein, with the mounting base attached at the interior portion of the vehicle, the vehicular interior rearview mirror assembly is operable in a mirror mode and is operable in a display mode;
wherein, with the mounting base attached at the interior portion of the vehicle, and with the vehicular interior rearview mirror assembly operating in the mirror mode, the driver of the vehicle views reflections at the mirror reflective element to view rearward of the vehicle, and wherein, with the mounting base attached at the interior portion of the vehicle, and with the vehicular interior rearview mirror assembly operating in the display mode, the video display screen is operated to display video images for viewing by the driver through the mirror reflective element;
a driver monitoring camera accommodated by the mirror head, wherein the driver monitoring camera moves together and in tandem with the mirror head when, with the mounting base attached at the interior portion of the vehicle, the mirror head is adjusted relative to the mounting base to set a rearward view of the driver of the vehicle;
wherein the driver monitoring camera is disposed behind a cover panel that is coated to render covert the driver monitoring camera to a person viewing the mirror reflective element when the vehicular interior rearview mirror assembly is installed in the vehicle;
wherein the cover panel is coated with a near infrared light transmissive coating that at least partially allows transmission of near infrared light and that at least partially blocks transmission of visible light;
a near infrared light emitter accommodated by the mirror head, wherein the near infrared light emitter moves together and in tandem with the mirror head when, with the mounting base attached at the interior portion of the vehicle, the mirror head is adjusted relative to the mounting base to set the rearward view of the driver of the vehicle;
wherein the near infrared light emitter is disposed behind the cover panel and near infrared light emitted by the near infrared light emitter passes through the cover panel;
wherein the near infrared light emitter is accommodated by the mirror head so that, with the mounting base attached at the interior portion of the vehicle and with the mirror head adjusted relative to the mounting base to set the rearward view of the driver of the vehicle, a beam of near infrared light emitted by the near infrared light emitter is directed toward a driver's region of the vehicle; and
wherein the driver monitoring camera is disposed adjacent to the video display screen so as to not view through the video display screen.

54. The vehicular driver monitoring system of claim 53, wherein the mirror head includes electronic circuitry, and wherein the electronic circuitry comprises a processor operable to process image data captured by the driver monitoring camera, and wherein, with the mounting base attached at the interior portion of the vehicle, the processor processes image data captured by the driver monitoring camera to determine at least one selected from the group consisting of (i) driver attentiveness, (ii) driver drowsiness and (iii) driver gaze direction.

55. The vehicular driver monitoring system of claim 53, wherein the driver monitoring camera does not view through the transflective mirror reflector of the mirror reflective element.

56. The vehicular driver monitoring system of claim 53, wherein the cover panel is accommodated by the mirror head and is disposed adjacent a lower edge of the mirror reflective element.

57. The vehicular driver monitoring system of claim 56, wherein an outer surface of the cover panel is coplanar with an outer surface of the mirror reflective element at the lower edge of the mirror reflective element.

58. The vehicular driver monitoring system of claim 56, wherein an outer surface of the cover panel is disposed at an oblique angle relative to an outer surface of the mirror reflective element at the lower edge of the mirror reflective element.

59. The vehicular driver monitoring system of claim 56, wherein an imager plane of the driver monitoring camera is parallel to an outer surface of the cover panel.

60. The vehicular driver monitoring system of claim 53, wherein the mirror reflective element comprises an electrochromic mirror reflective element having a front glass substrate and a rear glass substrate with an electrochromic medium sandwiched therebetween.

61. The vehicular driver monitoring system of claim 60, wherein the driver monitoring camera is disposed at least partially within a cutout region along a lower edge of the mirror reflective element, and wherein the near infrared light emitter is disposed at least partially within the cutout region.

62. The vehicular driver monitoring system of claim 53, wherein the mirror head comprises a chin portion extending from a lower edge region of the mirror head, and wherein the driver monitoring camera is at least partially accommodated by the chin portion of the mirror head, and wherein the cover panel extends from a lower edge region of the mirror reflective element and over and along the driver monitoring camera at the chin portion of the mirror head.

63. The vehicular driver monitoring system of claim 53, wherein a principal viewing axis of the driver monitoring camera is biased toward a driver side of the interior portion of the vehicle.

64. A vehicular driver monitoring system, the vehicular driver monitoring system comprising:
a vehicular interior rearview mirror assembly comprising a mirror head adjustably attached at a mounting base, the mounting base configured to attach at an interior portion of a vehicle equipped with the vehicular driver monitoring system;
wherein the mirror head accommodates a mirror reflective element;
wherein the mirror reflective element comprises an electrochromic mirror reflective element having a front glass substrate and a rear glass substrate with an electrochromic medium sandwiched therebetween;
wherein the mirror reflective element comprises a transflective mirror reflector, and wherein the transflective mirror reflector of the mirror reflective element transmits near infrared light incident thereon, transmits visible light incident thereon and reflects visible light incident thereon;
wherein the mirror reflective element comprises a reflective region defined by the transflective mirror reflector;
a video display device disposed rearward of the mirror reflective element;
wherein the video display device comprises a video display screen that occupies at least 75 percent of the reflective region of the mirror reflective element;
wherein the video display device is operable to display video images captured by a rearward viewing camera of the vehicle;
wherein, with the mounting base attached at the interior portion of the vehicle, and when the video display device is operated to display video images captured by the rearward viewing camera, visible light emitted by the video display device passes through the transflective mirror reflector of the mirror reflective element for viewing of displayed video images by a driver of the vehicle viewing the mirror reflective element;
wherein, with the mounting base attached at the interior portion of the vehicle, the vehicular interior rearview mirror assembly is operable in a mirror mode and is operable in a display mode;
wherein, with the mounting base attached at the interior portion of the vehicle, and with the vehicular interior rearview mirror assembly operating in the mirror mode, the driver of the vehicle views reflections at the mirror reflective element to view rearward of the vehicle, and wherein, with the mounting base attached at the interior portion of the vehicle, and with the vehicular interior rearview mirror assembly operating in the display mode, the video display screen is operated to display video images for viewing by the driver through the mirror reflective element;
a driver monitoring camera accommodated by the mirror head, wherein the driver monitoring camera moves together and in tandem with the mirror head when, with the mounting base attached at the interior portion of the vehicle, the mirror head is adjusted relative to the mounting base to set a rearward view of the driver of the vehicle;
wherein the driver monitoring camera is disposed behind and views through an overhang region of the front glass substrate that extends beyond the rear glass substrate, and wherein the driver monitoring camera does not view through the rear glass substrate;
wherein the overhang region of the front glass substrate is coated with a near infrared light transmissive coating that at least partially allows transmission of near infrared light and that at least partially blocks transmission of visible light;
a near infrared light emitter accommodated by the mirror head, wherein the near infrared light emitter moves together and in tandem with the mirror head when, with the mounting base attached at the interior portion of the vehicle, the mirror head is adjusted relative to the mounting base to set the rearward view of the driver of the vehicle;
wherein the near infrared light emitter is accommodated by the mirror head so that, with the mounting base attached at the interior portion of the vehicle and with the mirror head adjusted relative to the mounting base to set the rearward view of the driver of the vehicle, a beam of near infrared light emitted by the near infrared light emitter is directed toward a driver's region of the vehicle;
wherein the near infrared light emitter is disposed behind and emits near infrared light that passes through the overhang region of the front glass substrate; and
wherein the driver monitoring camera is disposed adjacent to the video display screen so as to not view through the video display screen.

65. The vehicular driver monitoring system of claim 64, wherein the mirror head includes electronic circuitry, and wherein the electronic circuitry comprises a processor operable to process image data captured by the driver monitoring camera, and wherein, with the mounting base attached at the interior portion of the vehicle, the processor processes image data captured by the driver monitoring camera to determine at least one selected from the group consisting of (i) driver attentiveness, (ii) driver drowsiness and (iii) driver gaze direction.

66. The vehicular driver monitoring system of claim 64, wherein the driver monitoring camera does not view through the transflective mirror reflector of the mirror reflective element.

67. The vehicular driver monitoring system of claim 64, wherein an imager plane of the driver monitoring camera is parallel to an outer surface of the front glass substrate of the mirror reflective element.

68. The vehicular driver monitoring system of claim 64, wherein an imager plane of the driver monitoring camera is disposed at an oblique angle relative to an outer surface of the front glass substrate of the mirror reflective element.

69. The vehicular driver monitoring system of claim 64, wherein the near infrared light transmissive coating is configured to block transmission of at least 75 percent of visible light incident at the near infrared light transmissive coating.

70. The vehicular driver monitoring system of claim 64, wherein the driver monitoring camera is disposed at least partially within a cutout region along a lower edge of the rear glass substrate, and wherein the near infrared light emitter is disposed at least partially within the cutout region.

71. The vehicular driver monitoring system of claim 64, wherein the mirror head comprises a chin portion extending from a lower edge region of the mirror head, and wherein the driver monitoring camera is at least partially accommodated by the chin portion of the mirror head.

72. The vehicular driver monitoring system of claim 64, wherein a principal viewing axis of the driver monitoring camera is biased toward a driver side of the interior portion of the vehicle.
